(19) United States
(12) Patent Application Publication
(10) Pub. No.: US 2026/0329710 A1
(43) Pub. Date: Oct. 22, 2026

(54) PROCESSOR INCLUDING BUILT-IN SELF-TEST CIRCUIT, METHOD OF OPERATING THE PROCESSOR, AND METHOD OF MANUFACTURING THE SAME

(71) Applicant: Samsung Electronics Co., Ltd., Suwon-si, Gyeonggi-do (KR)

(72) Inventors: Sungho KANG, Seoul (KR); Hyemin KIM, Seoul (KR)

(73) Assignees: Samsung Electronics Co., Ltd., Suwon-si, Gyeonggi-do (KR); UIF (University-Industry Foundation), Yonsei University, Seoul (KR)

(21) Appl. No.: 19/644,433

(22) Filed: Apr. 10, 2026

(30) Foreign Application Priority Data
Apr. 18, 2025 (KR) 10-2025-0051147

(51) Int. Cl. G06F 11/22; G06F 11/263

(52) U.S. Cl. CPC G06F 11/2284; G06F 11/263

(57) ABSTRACT

A processor includes a pattern generating circuit configured to output a test pattern of pseudo-random numbers, a plurality of scan chains, each including a plurality of scan cells connected in a chain, configured to scan-in the test pattern to the plurality of scan cells and scan-out a response of a circuit-under-test based on the test pattern, the circuit-under-test comprising logic circuits coupled to the plurality of scan cells, a weight applying circuit configured to apply a weight to an output signal of at least one scan cell among the plurality of scan cells, a control point circuit configured to share at least one element with the weight applying circuit, and a compacting circuit configured to output a signature obtained by compacting a test response of the circuit-under-test.

### CROSS-REFERENCE TO RELATED APPLICATION(S)

This U.S. non-provisional application claims priority under 35 USC § 119 to Korean Patent Application No. 10-2025-0051147, filed on Apr. 18, 2025, in the Korean Intellectual Property Office, the disclosure of which is herein incorporated by reference in its entirety.

### BACKGROUND

The present inventive concepts relate to processors including a Built-In Self-Test (BIST) circuit and methods of operating the same, and methods of designing the processors including the BIST circuit.

Field testing during the use of a processor is essential to ensuring stable operation of the processor. Preventing field failures in processors is especially relevant to the reliability of devices in automotive, railway, satellite, aerospace, telecommunications, and medical fields.

A Built-In-Self-Test (BIST) circuit is used in integrated circuits to improve the reliability of processors. The BIST circuit may include a circuit generating test patterns and a circuit compacting test responses.

A BIST circuit may have a lower test coverage than Automatic Test Equipment (ATE). Test point inserting (TPI) may be used in the BIST circuit to improve the test coverage of the BIST circuit.

### SUMMARY

Some example embodiments of the present inventive concepts provide a Built-In Self-Test (BIST) circuit with improved test coverage that is implemented through the use of additional circuitry occupying a significantly smaller area.

According to some example embodiments, a processor may include: a pattern generating circuit configured to transmit a test pattern of pseudo-random numbers; a scan chain, the scan chain including a plurality of scan cells connected in a chain, the scan chain configured to scan-in the test pattern to the plurality of scan cells and scan-out a test response of a circuit-under-test based on the test pattern, the plurality of scan cells coupled to at least one logic circuit of the circuit-under-test; a weight applying circuit and a control point circuit, the weight applying circuit and the control point circuit configured to share at least one shared element, the weight applying circuit configured to transmit a weighted output signal to the circuit-under-test by applying a weight to an output signal of at least one scan cell among the plurality of scan cells based on an operation performed by the at least one shared element, the control point circuit configured to selectively control blocking of an internal signal of the circuit-under-test and transmitting a pre-configured logic value to the circuit-under-test or transmitting the internal signal to the circuit-under-test without blocking, such that one of the pre-configured logic value or the internal signal is transmitted to the circuit-under-test based on the operation performed by the at least one shared element; and a compacting circuit configured to transmit a signature obtained based on compacting the test response of the circuit-under-test.

According to some example embodiments, a method of operating a processor may include: shifting-in a test pattern of pseudo-random numbers to a scan chain, the scan chain including a plurality of scan cells connected in a chain, the test pattern of the pseudo-random numbers being generated by a pattern generating circuit; transmitting a weighted test pattern to a circuit-under-test based on applying, by a weight applying circuit, a weight to an output signal of at least one scan cell among the plurality of scan cells, the applying based on an operation performed by at least one shared element; blocking, by a control point circuit sharing the at least one shared element with the weight applying circuit, an internal signal of the circuit-under-test and applying a pre-configured logic value to the circuit-under-test, the blocking and the applying based on the operation of the at least one shared element; and scanning-out a response of the circuit-under-test based on the weighted test pattern and the pre-configured logic value.

According to some example embodiments, a method of designing a processor may include: logically synthesizing a circuit to generate a logically synthesized circuit; analyzing deterministic patterns generated by an automatic test pattern generator based on the logically synthesized circuit to determine at least one weighting scan cell, into which a weight applying circuit is to be inserted, in the logically synthesized circuit; inserting the weight applying circuit into the logically synthesized circuit based on the at least one weighting scan cell; determining a control point node into which a first control point circuit is to be inserted, based on the logically synthesized circuit; determining a first weighting scan cell among the at least one weighting scan cell that satisfies a distance criterion with respect to the control point node; and inserting the first control point circuit, sharing one or more elements with the weight applying circuit connected to the first weighting scan cell, into the logically synthesized circuit.

### BRIEF DESCRIPTION OF DRAWINGS

FIG. 1 is a conceptual block diagram illustrating a processor according to some example embodiments.

FIG. 2 is a block diagram illustrating a processor according to some example embodiments in detail.

FIG. 3 is a conceptual diagram illustrating a scan chain and a weighting circuit according to some example embodiments.

FIGS. 4, 5, 6, and 7 are circuit diagrams of weighting circuits according to some example embodiments.

FIGS. 8 and 9 are diagrams illustrating examples of an AND gate-based control point circuit and an OR gate-based control point circuit, respectively, according to some example embodiments.

FIGS. 10, 11, 12, and 13 are circuit diagrams of a weight applying circuit and a control point circuit that share one or more elements with each other, according to some example embodiments.

FIG. 14 is a flowchart illustrating a method of operating a processor according to some example embodiments.

FIG. 15 is a flowchart illustrating a method of designing a processor according to some example embodiments.

FIG. 16 is a diagram illustrating selection of a weighting scan cell that satisfies a pre-configured distance criterion with a control point node into which a first control point circuit is to be inserted, according to some example embodiments.

FIG. 17 is a diagram illustrating re-convergence of output signals due to the insertion of a weight applying circuit, according to some example embodiments.

FIG. 18 is a flowchart illustrating a method of determining a weighting scan cell into which a weight applying circuit is to be inserted, according to some example embodiments.

FIG. 19 illustrates an automatic test pattern generator (ATPG) deriving five deterministic patterns, according to some example embodiments.

FIG. 20 is a schematic view illustrating an electronic device according to some example embodiments.

### DETAILED DESCRIPTION

The following description with reference to the accompanying drawings is provided to assist in a comprehensive understanding of some example embodiments of the present inventive concepts.

As the inventive concepts allow for various changes and numerous various example embodiments, some example embodiments will be illustrated in the drawings and described in detail in the written description. However, this is not intended to limit the inventive concepts to particular modes of practice, and it is to be appreciated that all modifications, equivalents, and substitutes that do not depart from the spirit and technical scope of the inventive concepts are encompassed in the inventive concepts. In describing the inventive concepts, when it is determined that the specific description of the known related art unnecessarily obscures the gist of the inventive concepts, the detailed description thereof will be omitted.

A portion of an element described as being “on” or “above” another element as used herein, it may include not only the meaning of “immediately on/under/to the left/to the right in a contact manner,” but also the meaning of “on/under/to the left/to the right in a non-contact manner.”

An expression used in the singular encompasses the expression of the plural, unless it has a clearly different meaning in the context. Unless explicitly described to the contrary, it is to be understood that the terms such as “including” and “having” are intended to indicate the existence of the features, numbers, steps, actions, components, parts, ingredients, materials, or combinations thereof disclosed in the specification and are not intended to preclude the possibility that one or more other features, numbers, steps, actions, components, parts, ingredients, materials, or combinations thereof may exist or may be added.

In order to clearly explain the present inventive concepts in the drawings, parts that are not related to the description are omitted, and similar parts are given similar reference numerals throughout the specification. Accordingly, it will be understood that like reference numbers refer to like elements throughout the specification, such that the same or similar constituent elements are indicated by the same reference numeral throughout the specification. In the methods described herein, the order of operations may be changed, several operations may be merged, certain operations may be divided, and certain operations may not be performed.

Additionally, expressions written in the singular may be interpreted as singular or plural, unless explicit expressions such as “one” or “single” are used. Terms containing ordinal numbers, such as first, second, etc., may be used to describe various elements, but the elements are not limited by these terms. These terms may be used for the purpose of distinguishing one component from another.

Throughout the specification, the term “connected” does not mean only that two or more constituent components are directly connected, but may also mean that two or more constituent components are indirectly connected through another constituent component. In addition, unless explicitly described to the contrary, the word “comprise”, and variations such as “comprises” or “comprising”, will be understood to imply the inclusion of stated elements but not the exclusion of any other elements.

It will be understood that elements and/or properties thereof may be recited herein as being “identical”, “the same”, or “equal” as other elements and/or properties thereof, and it will be further understood that elements and/or properties thereof recited herein as being “identical” to, “the same” as, or “equal” to other elements and/or properties thereof may be “identical” to, “the same” as, or “equal” to or “substantially identical” to, “substantially the same” as or “substantially equal” to the other elements and/or properties thereof. Elements and/or properties thereof that are “substantially identical” to, “substantially the same” as or “substantially equal” to other elements and/or properties thereof will be understood to include elements and/or properties thereof that are identical to, the same as, or equal to the other elements and/or properties thereof within manufacturing tolerances and/or material tolerances. Elements and/or properties thereof that are identical or substantially identical to, equal to or substantially equal to, and/or the same or substantially the same as other elements and/or properties thereof may be structurally the same or substantially the same, functionally the same or substantially the same, and/or compositionally the same or substantially the same. While the term “same,” “equal” or “identical” may be used in description of some example embodiments, it should be understood that some imprecisions may exist. Thus, when one element or property is referred to as being identical to, equal to, or the same as another element or property, it should be understood that the element or property is the same as another element or property within a desired manufacturing or operational tolerance range (e.g., ±10%).

It will be understood that elements and/or properties thereof described herein as being “substantially” the same, equal, and/or identical encompasses elements and/or properties thereof that have a relative difference in magnitude that is equal to or less than 10%. Further, regardless of whether elements and/or properties thereof are modified as “substantially,” it will be understood that these elements and/or properties thereof should be construed as including a manufacturing or operational tolerance (e.g., ±10%) around the stated elements and/or properties thereof.

When the terms “about” or “substantially” are used in this specification in connection with a numerical value, it is intended that the associated numerical value includes a manufacturing or operational tolerance (e.g., ±10%) around the stated numerical value. Moreover, when the words “about” and “substantially” are used in connection with geometric shapes, it is intended that precision of the geometric shape is not required but that latitude for the shape is within the scope of the disclosure. Further, regardless of whether numerical values or shapes are modified as “about” or “substantially,” it will be understood that these values and shapes should be construed as including a manufacturing or operational tolerance (e.g., ±10%) around the stated numerical values or shapes. When ranges are specified, the range includes all values therebetween such as increments of 0.1%.

As described herein, when an operation is described to be performed, or an effect such as a structure is described to be established “by” or “through” performing additional operations, it will be understood that the operation may be performed and/or the effect/structure may be established “based on” the additional operations, which may include performing said additional operations alone or in combination with other further additional operations.

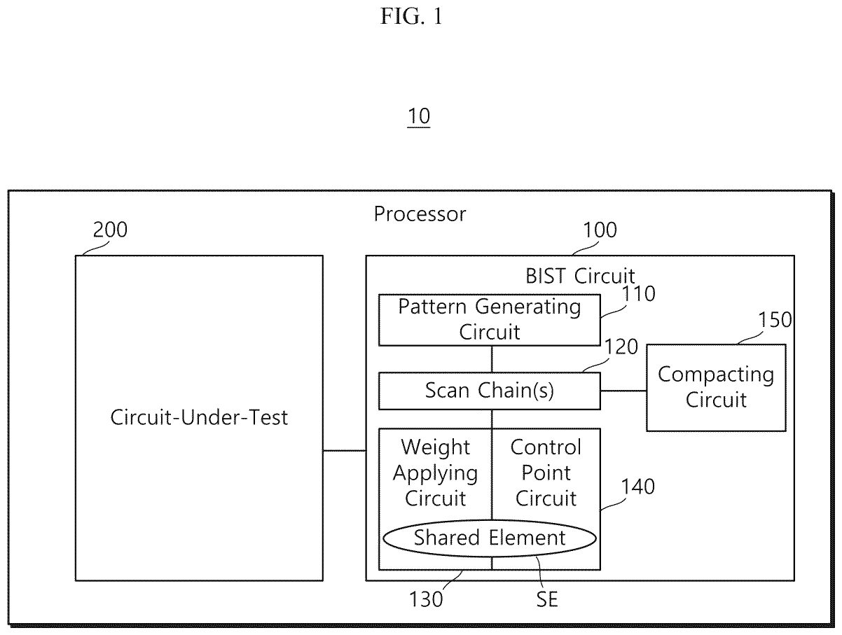

FIG. 1 is a conceptual block diagram illustrating a processor 10 according to some example embodiments.

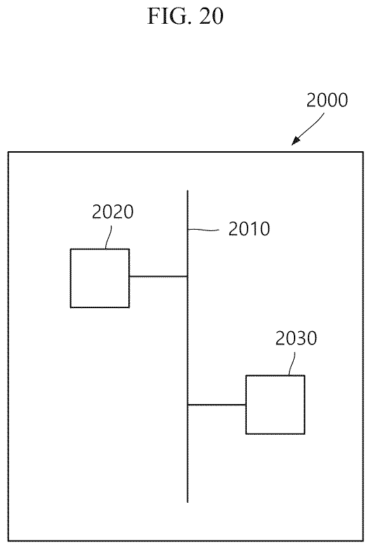

The processor 10 according to some example embodiments may include a Built-In Self-Test (BIST) circuit 100. The BIST circuit 100 may include a pattern generating circuit 110, a scan chain 120, a compacting circuit 150, a weight applying circuit 130, and a control point circuit 140. The weight applying circuit 130 and the control point circuit 140 may share at least certain components with each other. In some example embodiments, some or all of the processor 10 may be included in and/or implemented by the electronic device 2000 shown in FIG. 20.

Referring to FIG. 1, the processor 10 may include a BIST circuit 100 and a Circuit-Under-Test (CUT) 200.

In some example embodiments, the processor 10 may include a plurality of BIST circuits 100 for each CUT 200.

The CUT 200 may be a logic circuit that performs at least certain functions of a processor 10 in a normal mode. The CUT 200 may include at least one logic circuit, a plurality of logic circuits, or the like. The CUT 200 may be a test target of a BIST circuit 100 in a test mode (e.g., based on the processor 10, the BIST circuit 100, or any portion thereof operating in a test mode). The CUT 200 may be a portion of a module of a processor 10 or a portion of a logic circuit.

The BIST circuit 100 may be a logic BIST (LBIST) circuit performing a test on a logic circuit.

The BIST circuit 100 may input (e.g., transmit) a test pattern, generated by the pattern generating circuit 110, to the CUT 200 through the scan chain 120. The compacting circuit 150 may compact a test response output by the CUT 200.

In some example embodiments, the BIST circuit 100 may generate a signature from the compacted test response. In some example embodiments, the BIST circuit 100 may compare the generated signature with a pre-stored signature and determine a fault of the CUT 200 based on a comparison result. The processor 10 may implement a fault-detection response operation in response to determining the fault of the CUT 200, including for example initiating a reset, shutdown, bypass, and/or a repair of the CUT or any portion thereof (e.g., including resetting the program of instructions executed to operate some or all of the CUT) to adjust operation of the CUT 200 to repair or bypass the determined fault, transmitting a warning signal (e.g., to a user interface coupled to the processor 10, to an electronic device communicatively coupled with the processor 10, or the like) indicating the determination of the fault, any combination thereof, or the like.

The BIST circuit 100 according to some example embodiments may include a weight applying circuit 130 and a control point circuit 140. The BIST circuit 100 may include at least one weight applying circuit 130 and at least one control point circuit 140.

The weight applying circuit 130 may apply a weight to an output signal of any one scan cell among a plurality of scan cells included in a scan chain 120, so as to generate a weighted output signal. For example, the weight applying circuit 130 may apply a weight to an output signal of at least one scan cell among the plurality of scan cells included in a scan chain 120 and may transmit the weighted output signal to the CUT 200 based on applying the weight to the output signal of the at least one scan cell. As a result, the output signal of the scan cell (or the at least one scan cell) may be modified by the weight applying circuit 130. For example, the weight applying circuit 130 may apply a weight to the output signal of at least one scan cell among the plurality of scan cells included in a scan chain 120 to modify the output signal into a modified output signal, also referred to herein interchangeably as a weighted output signal. The modification of the output signal of the scan cell may be, or include, a change, caused by the weight applying circuit 130, in a logic value of certain bits (e.g., one or more bits) of a test pattern included in and/or indicated by the output signal.

The weight applying circuit 130 may apply a weight such that a specific bit combination occurs more frequently in the test pattern included in and/or indicated by the output signal. For example, the weight applying circuit 130 may, based on applying a weight to the output signal, change the probability that certain bits of the test pattern stored in the scan cell are a logic ‘1,’ and then may apply the weighted test pattern to a circuit under test (CUT) 200.

The weight applying circuit 130 may be coupled to at least one scan cell of the plurality of scan cells included in the scan chain 120. For example, the weight applying circuit 130 may be coupled to a scan cell corresponding to a bit to be weighted in the test pattern. A scan cell corresponding to a bit to be weighted may be referred to as a weighting scan cell in the present specification. The weight applying circuit 130 may receive an output signal of the weighting scan cell.

In some example embodiments, the weight applying circuit 130 may also be coupled to at least one scan cell disposed immediately before the weighting scan cell in the same scan chain as the weighting scan cell. In the present specification, a scan cell that is disposed in the same scan chain as the weighting scan cell and is disposed immediately before the weighting scan cell may be referred to as a load scan cell. The weight applying circuit 130 may receive an output signal of at least one load scan cell.

A control point may be a test point. When the probability that the logic value of an internal signal of a specific node of the CUT 200 is logic ‘1’ is significantly low or high (e.g., less than 20% or greater than 80%), for example in response to a determination of same at the control point circuit 140, the control point circuit 140 may forcibly control a logic value of the internal signal of the specific node, for example based on selectively blocking an internal signal of the CUT 200 and transmitting a pre-configured logic value to the CUT 200 instead (e.g., as part of a “forcibly applied signal” transmitted to the CUT 200), where such selective blocking may be based on an operation (e.g., a logical operation) performed by the at least one shared element SE that is shared with the weight applying circuit 130.

The detection probability of random pattern resistant faults of a processor 10 may be improved, and test coverage may be increased by the weight applying circuit 130 and the control point circuit 140.

The weight applying circuit 130 and the control point circuit 140 may share at least one element, referred to herein as a shared element SE. For example, the weight applying circuit 130 and the control point circuit 140 may share one or more particular components, such that each of the weight applying circuit 130 and the control point circuit 140 may operate using one or more same (common) shared components, which are also referred to herein as one or more shared elements SE.

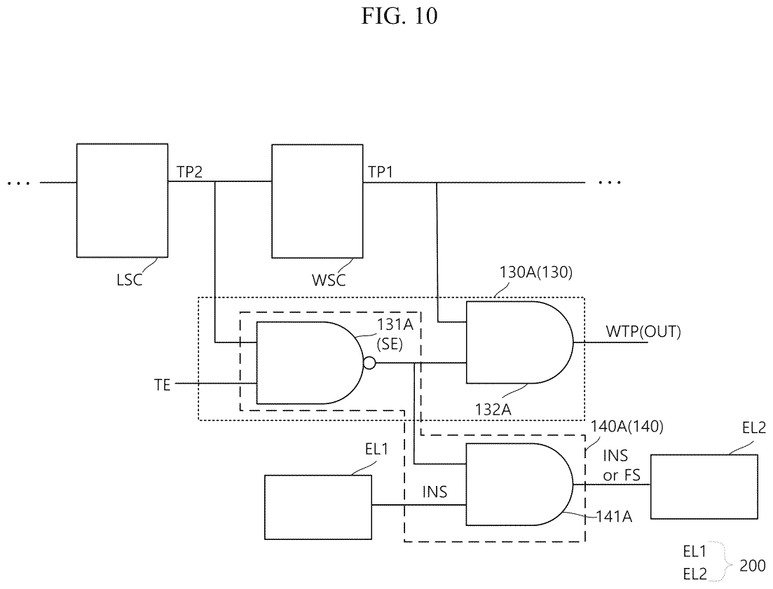

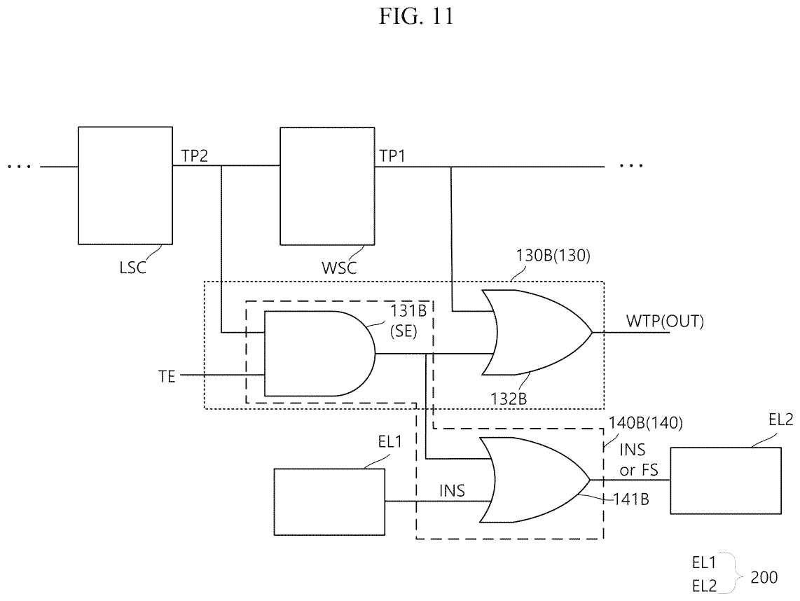

As described herein, a shared element SE that is shared by a weight applying circuit 130 and a control point circuit 140 may include a device (e.g., a circuitry device, and electronic device, or the like) that is configured to perform an operation, including for example a logic operation (e.g., a Boolean function). For example, a shared element SE may be a shared circuit. For example, a shared element SE may include a logic gate device. A logic gate device (which may be referred to interchangeably herein as a “logic gate,” a “logic circuit,” or the like), may include or may be implemented by a diode, a transistor (for example a metal-oxide-semiconductor field-effect transistor (MOSFET)), an electronic switch device, or any combination thereof, and thus a shared element SE may include or may be such a diode, a transistor (for example a metal-oxide-semiconductor field-effect transistor (MOSFET)), an electronic switch device, or any combination thereof. For example, a shared element SE may include, for example, a NAND gate such as shown in FIG. 10 (NAND gate 131A), an AND gate such as shown in FIG. 11 (AND gate 131B), or the like, although example embodiments are not limited thereto, and for example the shared element SE may include any logic circuit, logic gate, or any device that is configured to perform a logic operation. The weight applying circuit 130 and the control point circuit 140 may share the shared element SE based on each of the weight applying circuit 130 and the control point circuit 140 being configured to perform a respective operation (e.g., a respective logical operation) based on the same operation (e.g., logical operation, Boolean function, etc.) performed by the shared element SE, including for example using the same output or output signal of the shared element SE resulting from the shared element SE performing the operation (e.g., logical operation) as an input to one or more elements respective elements (e.g., respective logic gates) of the weight applying circuit 130 and the control point circuit 140. For example, the weight applying circuit 130 and the control point circuit 140 may share a shared element SE that includes at least one gate. For example, a shared element may perform a logical operation (e.g., a Boolean operation), and the weight applying circuit 130 may transmit a weighted output signal to the CUT 200 based on applying a weight to an output signal of at least one scan cell among the plurality of scan cells based on the logical operation performed by the at least one shared element (or the output or output signal of the shared element SE based on the shared element SE performing the logical operation), while the control point circuit 140 may selectively control blocking of an internal signal of the CUT 200 and transmitting a pre-configured logic value to the CUT 200 or transmitting the internal signal to the CUT 200 without blocking, such that one of the pre-configured logic value or the internal signal is transmitted to the CUT 200, based on the logical operation performed by the at least one shared element (or the output or output signal of the shared element SE based on the shared element SE performing the logical operation).

Due to both the weight applying circuit 130 and the control point circuit 140 being included in the processor 10 according to some example embodiments and sharing at least one shared element SE so as to each operation based on an operation performed by the at least one shared element SE, a circuit area of the processor 10 that is occupied by the weight applying circuit 130 and the control point circuit 140 may be reduced while still improving the likelihood of the processor 10 to detect random pattern resistant faults. For example, the processor 10, including the BIST circuit 100, may be configured to exhibit improved detection of random pattern resistant faults in the CUT 200 while having a reduced size based on the weight applying circuit 130 and the control point circuit 140 sharing at least one shared element SE. For example, the processor 10, including the BIST circuit 100, may be configured to exhibit reduced size without compromising the ability of the processor (e.g., the BIST circuit 100) to detect random pattern resistant faults in the CUT 200 (and in some example embodiments to perform one or more operations in response to such detection of random pattern resistant faults). As a result, the functionality of the processor 10 may be improved based on the BIST circuit 100 including the scan chain 120 and weight applying circuit 130 and control point circuit 140 that share at least one shared element SE. The processor 10 may perform a fault-detection response operation in response to determining the fault of the CUT 200, including for example initiating a reset and/or a repair of the CUT or any portion thereof to adjust operation of the CUT 200 to repair or bypass the determined fault, transmitting a warning signal (e.g., to a user interface coupled to the processor 10, to an electronic device communicatively coupled with the processor 10, or the like) indicating the determination of the fault, any combination thereof, or the like. As a result, the processor 10 may be configured to detect faults of the CUT 200 while exhibiting a reduced size or area, based on the sharing of at least one shared element SE between the weight applying circuit 130 and the control point circuit 140, and thus may exhibit the reduced size or area without comprising fault detection abilities that may proceed at least to detecting the fault and performing one or more fault-detection response operations, based on the weight applying circuit and the control point circuit operating based on the operation of the at least one shared element SE.

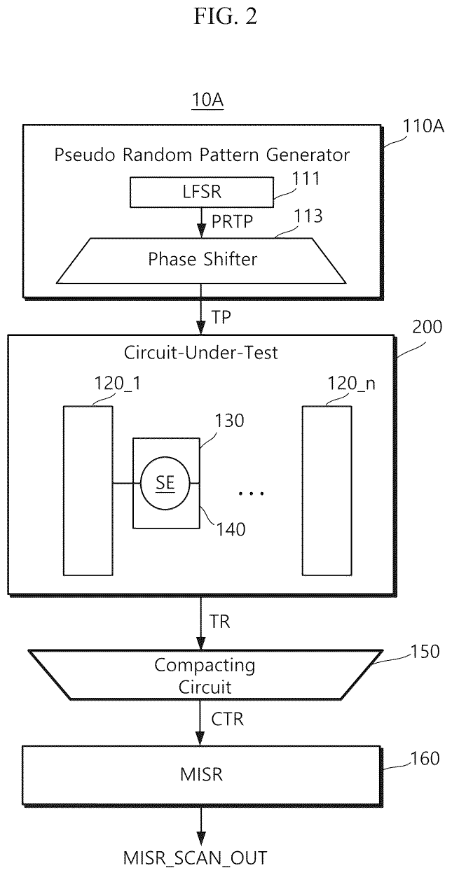

FIG. 2 is a block diagram illustrating a processor 10A according to some example embodiments in detail. The processor 10A of FIG. 2 may correspond to the processor 10 of FIG. 1. For example, the processor 10A of FIG. 2 may be included in and/or implemented by the processor 10 of FIG. 1. In some example embodiments, some or all of the processor 10A may be included in and/or implemented by the electronic device 2000 shown in FIG. 20.

Referring to FIG. 2, the processor 10A may include a pseudo-random pattern generator 110A, a plurality of scan chains 120_1 to 120_n (where n is a positive integer greater than or equal to 2), a weight applying circuit 130, a control point circuit 140, a compacting circuit 150, and a multiple input signature register (MISR) 160.

The pseudo-random pattern generator 110A may correspond to (e.g., may be included in and/or implemented by) the pattern generating circuit 110 shown in FIG. 1. In some example embodiments, the pseudo-random pattern generator 110A may include a linear feedback shift register (LFSR) 111 and a phase shifter 113.

The LFSR 111 may generate a test pattern, for example a pseudo-random pattern, for example a pseudo-random test pattern (PRTP). For example, the LFSR 111 may include a D flip-flop and an XOR gate, and may be implemented with various known structures.

The phase shifter 113 may remove the correlation of the pseudo-random pattern generated by the LFSR 111. The phase shifter 113 may generate a test pattern TP with the correlation removed.

In some example embodiments, the phase shifter 113 may be implemented using various known circuits, such as a structure in which an independent test pattern is generated by performing an XOR operation on a plurality of pseudo-random patterns output by the LFSR 111, or a structure in which bits at a specific position of the pseudo-random pattern are shifted to another position.

The test pattern TP may be transmitted, for example scanned-in, to the plurality of scan chains 120_1 to 120_n.

Each scan chain of the plurality of scan chains 120_1 to 120_n may include a plurality of scan cells. Each scan cell may include a flip-flop or a latch. This specification describes the case where a scan cell includes a flip-flop, but the scan cell may include an element other than a flip-flop. The scan cell may include a multiplexer.

The scan cells included in each scan chain of the plurality of scan chains 120_1 to 120_n may be connected to each other in a serial chain. For example, at least some of the flip-flops included in the CUT 200 may be connected in a chain through a scan design.

In a scan-in mode, the processor 10A may be configured to cause bits of the test pattern TP to be sequentially shifted-in (“scan-in”) toward the scan chains 120_1 to 120_n.

The weight applying circuit 130 may receive the output signal of at least one scan cell, apply a weight to the output signal to generate a weighted output signal, and transmit the weighted output signal to the CUT 200, where the weight applying circuit 130 may perform the applying and the transmitting based on an operation performed by the at least one shared element SE. According to some example embodiments, the weight applying circuit 130 may apply a weight to the test pattern TP that has been scanned-in to the scan chains 120_1 to 120_n to generate a weighted test pattern TP, and then transmit (e.g., inject) the weighted test pattern TP into the CUT 200. The weighted test pattern TP may be transmitted (applied) to a logic circuit of the CUT 200 that is coupled to the scan cells of at least one scan chain.

For example, at least one bit of the test pattern TP may be weighted by the weight applying circuit 130, for example such that the logic value of at least one bit position of the test pattern TP may be changed by the weight applying circuit 130 to generate a weighted test pattern. The probability that the logic value is to be changed may be based on the structure of the weight applying circuit 130.

In some example embodiments, weight applying circuits 130 having different structures may be coupled to different scan cells, respectively.

The control point circuit 140 may receive an output signal of a weighting scan cell or a load scan cell coupled to the weight applying circuit 130, and a test enable signal as an input (collectively, input signals). Based on the input signals, the control point circuit 140 may block an internal signal input to a specific node inside the CUT 200 and apply a signal with a specific logic value. The control point circuit 140 may share at least one element (SE) with the weight applying circuit 130. The processor 10A or any portion thereof, for example the control point circuit 140, may operate in a test mode based on a test enable signal TE (e.g., based on the control point circuit 140 receiving the test enable signal TE).

In some example embodiments, the element that receives the output signal of a weighting scan cell or a load scan cell coupled to the weight applying circuit 130, and the test enable signal TE in the control point circuit 140 may be received at a shared element SE that is shared with the weight applying circuit 130. For example, the shared element SE may include a device (e.g., a logic gate device) that is configured to perform an operation (e.g., a logical operation) based on the output signal of a weighting scan cell or a load scan cell coupled to the weight applying circuit 130, and further based on the test enable signal TE.

For example, based on the input signals, the control point circuit 140 may apply a logic “1” signal to a specific node, or may apply a logic “0” signal to a specific node. In the present specification, the forcibly applied signal that may be transmitted from the control point circuit 140 the CUT 200 to transmit a pre-configured logic value to the CUT 200 may be referred to as a control point signal, and the node to which the control point signal is applied may be referred to as a control point node. The control point node may be determined by various known test point insertion (TPI) techniques.

The CUT 200 may output (transmit) a test response TR based on the weighted test pattern TP and the control point signal. For example, the processor 10A may perform a circuit operation based on the weighted test pattern TP and the control point signal, and the test response TR, which is the result of the circuit operation, may be stored in the scan cells.

The test response TR may be transmitted (e.g., scanned-out) from the scan chain 120_1 to 120_n. For example, the test response TR may be transmitted (e.g., shifted-out) toward the outside of the scan chains 120_1 to 120_n, and the scanned-out test response may be input (e.g., transmitted) to the MISR 160. Accordingly, it will be understood that the processor 10 may transmit (e.g., shift-in) the test pattern TP to one or more of the scan chains 120_1 to 120_n, transmit (e.g., apply) the test pattern TP to the CUT 200, capture the test response TR of the CUT 200, and transmit (e.g., shift-out) the test response TR to the one or more of the scan chains 120_1 to 120_n.

The MISR 160 may compact the test response TR to generate and output (e.g., transmit) a signature signal MISR_SCAN_OUT. As a result, the MISR 160, alone or in combination with the compacting circuit 150, may transmit a signature obtained based on compacting a test response TR of the CUT 200, where the test response TR of the CUT 200 is transmitted from the CUT based on the weighted output signal that is transmitted to the CUT 200 by the weight applying circuit 130 and the one of the pre-configured logic value or the internal signal that is transmitted to the CUT 200 by the control point circuit 140. In some example embodiments, the processor 10A is configured to determine a fault of the CUT 200, including for example a random pattern resistant fault, based on comparing the signature with a pre-stored signature that may be stored in a memory of the processor 10A (e.g., memory 2030 shown in FIG. 20). The processor 10A may perform a fault-detection response operation in response to determining the fault of the CUT 200, including for example initiating a reset and/or a repair of the CUT or any portion thereof to adjust operation of the CUT 200 to repair or bypass the determined fault, transmitting a warning signal (e.g., to a user interface coupled to the processor 10A, to an electronic device communicatively coupled with the processor 10A, or the like) indicating the determination of the fault, any combination thereof, or the like. As a result, the processor 10A may be configured to detect faults of the CUT 200 while exhibiting a reduced size or area, based on the sharing of at least one shared element SE between the weight applying circuit 130 and the control point circuit 140, and thus may exhibit the reduced size or area without comprising fault detection abilities that may proceed at least to detecting the fault and performing one or more fault-detection response operations, based on the weight applying circuit and the control point circuit operating based on the operation of the at least one shared element SE.

According to some example embodiments, the processor 10A may include a logic circuit compressing the signature MISR_SCAN_OUT based on the test response TR with a prestored signature.

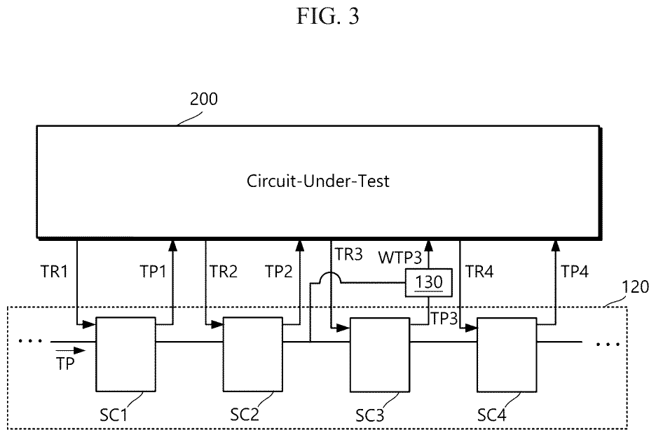

FIG. 3 is a conceptual diagram illustrating a scan chain 120 and a weight applying circuit 130 according to some example embodiments. The scan chain 120 and the weight applying circuit 130 of FIG. 3 may correspond to (e.g., may be included and/or implemented by) the scan chain 120 and the weight applying circuit 130 of FIG. 1, respectively. In FIG. 3, only one single scan chain 120 is illustrated as an example, but the processor may include a plurality of scan chains as described with reference to FIGS. 1 and 2.

Referring to FIG. 3, the scan chain 120 may include a plurality of scan cells SC1, SC2, SC3, and SC4. FIG. 3 illustrates as an example in which the scan chain 120 includes four scan cells SC1, SC2, SC3, and SC4, but the scan chain 120 may include a larger or smaller number (quantity) of scan cells.

The test pattern TP may be transmitted (e.g., scanned-in) to the scan chain 120. For example, each bit of the test pattern TP may be sequentially transmitted (e.g., shifted) to the scan cells SC1, SC2, SC3, and SC4 connected in series inside the scan chain 120.

The test pattern TP, which has been scanned-in to the scan chain 120, may be applied (transmitted) to the CUT 200.

Each of the scan cells SC1, SC2, SC3, and SC4 may apply the test pattern TP to each of the coupled logic circuits of the CUT 200. For example, each of the scan cells SC1, SC2, SC3, and SC4 may output (transmit) each bit TP1, TP2, TP3, and TP4 of the test pattern TP. The output bit of the test pattern TP may be applied to the CUT 200 as it is, or may be applied to the CUT 200 after being weighted (or modified) by the weight applying circuit 130 to generate one or more weighted test patterns.

A portion of the scan cells of the scan chain 120 according to some example embodiments may be coupled to the weight applying circuit 130. The weight applying circuit 130 may apply a weight to a bit of the test pattern TP input from the coupled scan cell.

In contrast, a weight applying circuit according to the related art is disposed between scan chains and a phase shifter, and thus is unable to share an element (e.g., a circuit component, electronic component, transistor, etc.) with the control point circuit.

Referring to FIG. 3, the weight applying circuit 130 may apply a weight to a bit TP3 of the test pattern TP output by the weighting scan cell SC3 to generate a weighted bit WTP3, and then may apply (transmit) the weighted bit WTP3 of the test pattern to the CUT 200.

In some example embodiments, the weight applying circuit 130 may be coupled to a load scan cell SC2 that is disposed in the same scan chain as the weighting scan cell SC3 and is disposed before the weighting scan cell SC3, where the weight applying circuit 130 may be coupled to the line between the load scan cell SC2 and the weighting scan cell SC3. As a result, the weight applying circuit 130 may be configured to receive an output signal of a load scan cell SC2 that is disposed in the same scan chain as the weighting scan cell SC3 and is disposed before the weighting scan cell SC3 so that the weight applying circuit 130 may receive the output signal of the load scan cell SC2 independently of the weighting scan cell SC3. The weight applying circuit 130 may modify the output signal of the weighting scan cell SC3 based on the output signal of the load scan cell SC2, which may be received at the weight applying circuit 130 independently of the weighting scan cell SC3 based on the weight applying circuit 130 being coupled to the load scan cell SC2 independently of the weighting scan cell SC3.

In some example embodiments, the weight applying circuit 130 may modify the output signal of the weighting scan cell SC3 based on output signals of a plurality of load scan cells. For example, referring to FIG. 3, the weight applying circuit 130 is illustrated as receiving an output signal of one load scan cell SC2, but the weight applying circuit 130 may receive output signals of a plurality of load scan cells. For example, the weight applying circuit 130 may be coupled to both scan cells SC1 and SC2 independently of the weighting scan cell SC3 and thus may be configured to receive output signals of the load scan cells SC1 and SC2. The weight applying circuit 130 may modify the output signal of the weighting scan cell SC3 based on the received output signals of the load scan cells SC1 and SC2.

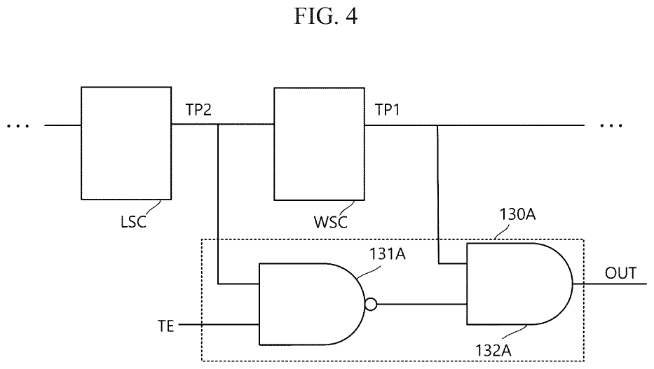

FIGS. 4, 5, 6, and 7 are circuit diagrams of weight applying circuits 130A, 130B, 130C, and 130D according to some example embodiments. The weight applying circuits 130A, 130B, 130C, and 130D described with reference to FIGS. 4 to 7 may correspond to, and thus may be included in and/or implemented by, the weight applying circuit 130 of FIGS. 1 and/or 2.

For clarity, the CUT 200 is not illustrated in FIGS. 4 to 7, but an output signal OUT of the weight applying circuits 130A, 130B, 130C, and 130D may be applied (transmitted) to the CUT 200.

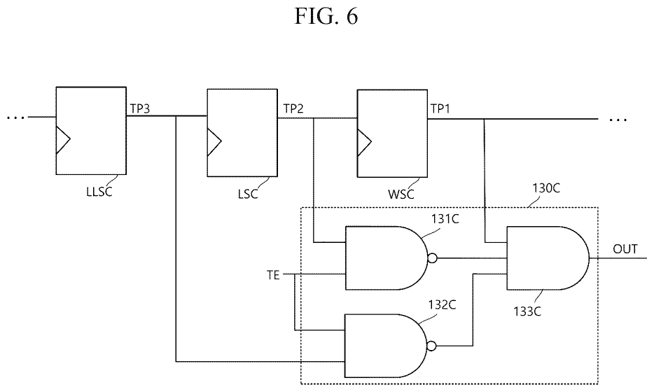

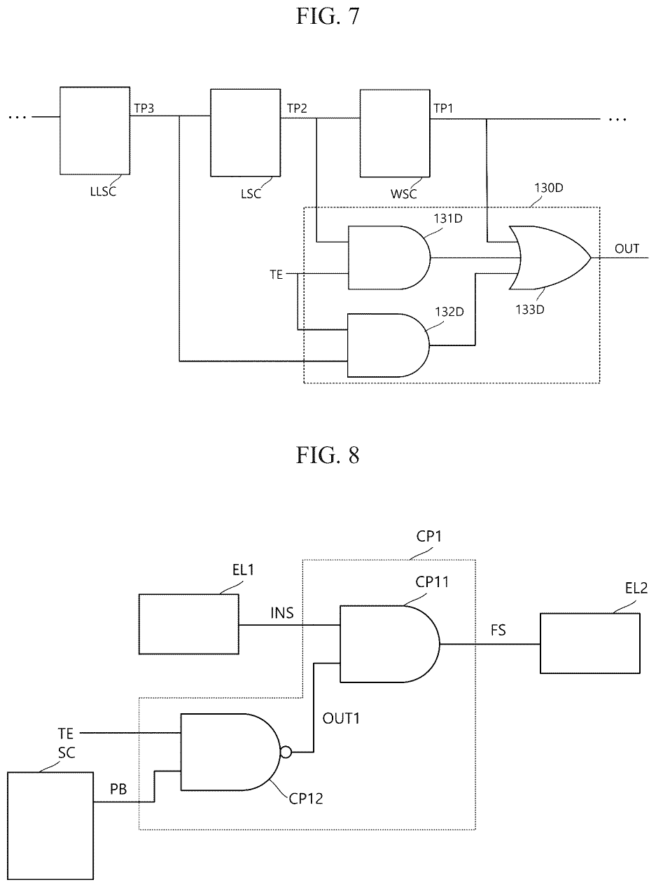

The weight applying circuits 130A, 130B, 130C, and 130D described with reference to FIGS. 4 to 7 are examples of the weight applying circuit 130 of FIG. 1, and the present inventive concepts are not limited to the weight applying circuits 130A, 130B, 130C, and 130D of FIGS. 4 to 7, and other structures of weight applying circuits capable of applying a weight to a test pattern may be used. Referring to FIGS. 4 to 7, in some example embodiments the weight applying circuit 130 is configured to receive, as input signals, at least a first output signal of at least one scan cell (e.g., a weighting scan cell WSC) and a second output signal of at least one separate scan cell (e.g., a load scan cell LSC) among the plurality of scan cells of a scan chain 120, and the weight applying circuit 130 may apply a weight to an output signal of the at least one scan cell (e.g., the weighting scan cell WSC) based on some or all of such input signals. Referring to FIGS. 6 and 7, the weight applying circuit 130 may be configured to receive, as input signals, each of a first output signal of at least one scan cell (e.g., a weighting scan cell WSC) and second output signals of at least two scan cells (e.g., at least two load scan cells LSC and LLSC) among the plurality of scan cells of a scan chain 120, and the weight applying circuit 130 may apply a weight to an output signal of the at least one scan cell (e.g., the weighting scan cell WSC) based on some or all of such input signals.

Referring to FIG. 4, a weight applying circuit 130A may be configured to reduce the probability that a bit of the test pattern of a weighting scan cell WSC is a logic ‘1.’ For example, the weight applying circuit 130A of FIG. 4 may be configured to modify a bit of the test pattern included in a first output signal TP1 to a logic ‘1’ with a probability of 0.25.

Referring to FIG. 4, a weighting scan cell WSC may output a first output signal TP1, and a load scan cell LSC may output a second output signal TP2. In a scan-in operation, the weighting scan cell WSC may receive the second output signal TP2 of the load scan cell LSC. The weighting scan cell WSC may output the first output signal TP1 based on the second output signal TP2.

The weight applying circuit 130A may include a NAND gate 131A and an AND gate 132A.

The NAND gate 131A may receive a test enable signal TE and the second output signal TP2 of the load scan cell LSC.

The AND gate 132A may receive the first output signal TP1 of the weighting scan cell WSC and an output signal of the NAND gate 131A. The first output signal TP1 of the weighting scan cell WSC may be modified to a logic ‘1’ in the AND gate 132A with a probability of 0.25 based on the output signal of the NAND gate 131A.

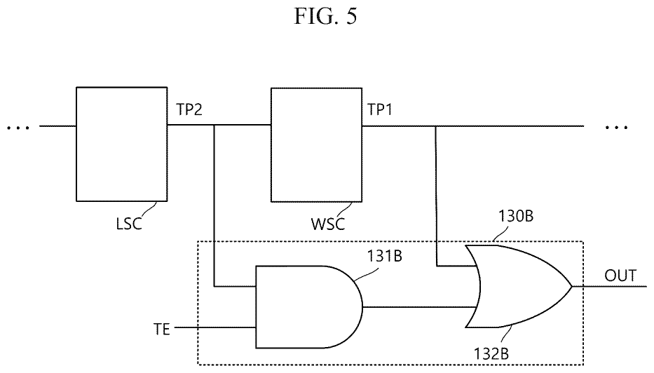

Referring to FIG. 5, the weight applying circuit 130B may be configured to increase the probability that a bit of the test pattern of a weighting scan cell WSC is a logic ‘1.’ For example, the weight applying circuit 130B of FIG. 5 may be configured to modify a bit of the test pattern included in the first output signal TP1 to a logic ‘1’ with a probability of 0.75.

Referring to FIG. 5, a weight applying circuit 130B may include an AND gate 131B and an OR gate 132B.

The AND gate 131B may receive a test enable signal TE and the second output signal TP2 of the load scan cell LSC.

The OR gate 132B may receive the first output signal TP1 of the weighting scan cell WSC and an output signal of the AND gate 131B. The first output signal TP1 of the weighting scan cell WSC may be modified to a logic ‘1’ in the OR gate 132B with a probability of 0.75 based on the output signal of the AND gate 131B.

Referring to FIG. 6, a weight applying circuit 130C may be configured to reduce the probability that a bit of the test pattern of a weighting scan cell WSC is a logic ‘1’. For example, the weight applying circuit 130C of FIG. 6 may be configured to modify a bit of the test pattern included in the first output signal TP1 to a logic ‘1’ with a probability of 0.125.

Referring to FIG. 6, a weighting scan cell WSC may output a first output signal TP1, a first load scan cell LSC may output a second output signal TP2, and a second load scan cell LLSC may output a third output signal TP3. In a scan-in operation, the weighting scan cell WSC may receive the second output signal TP2 of the first load scan cell LSC, and the first load scan cell LSC may receive the third output signal TP3 of the second load scan cell LLSC.

The weight applying circuit 130C may include two NAND gates 131C and 132C and an AND gate 133C.

The first NAND gate 131C may receive a test enable signal TE and the second output signal TP2 of the first load scan cell LSC, and the second NAND gate 132C may receive the test enable signal TE and the third output signal TP3 of the second load scan cell LLSC.

The AND gate 133C may receive the first output signal TP1 of the weighting scan cell WSC and output signals of the two NAND gates 131C and 132C. The first output signal TP1 of the weighting scan cell WSC may be modified to a logic ‘1’ in the AND gate 133C with a probability of 0.125 based on the output signals of the two NAND gates 131C and 132C.

Referring to FIG. 7, a weight applying circuit 130D may be configured to increase the probability that a bit of the test pattern of a weighting scan cell WSC is a logic ‘1’. For example, the weight applying circuit 130D of FIG. 7 may be configured to modify a bit of the test pattern included in the first output signal TP1 to a logic ‘1’ with a probability of 0.875.

Referring to FIG. 7, a weighting scan cell WSC may output a first output signal TP1, a first load scan cell LSC may output a second output signal TP2, and a second load scan cell LLSC may output a third output signal TP3. In a scan-in operation, the weighting scan cell WSC may receive the second output signal TP2 of the first load scan cell LSC, and the first load scan cell LSC may receive the third output signal TP3 of the second load scan cell LLSC.

The weight applying circuit 130D may include two AND gates 131D and 132D and an OR gate 133D.

The first AND gate 131D may receive a test enable signal TE and the second output signal TP2 of the first load scan cell LSC, and the second AND gate 132D may receive the test enable signal TE and the third output signal TP3 of the second load scan cell LLSC.

The OR gate 133D may receive the first output signal TP1 of the weighting scan cell WSC and output signals of the two AND gates 131D and 132D. The first output signal TP1 of the weighting scan cell WSC may be modified to a logic ‘1’ in the OR gate 133D with a probability of 0.875 based on the output signals of the two AND gates 131D and 132D.

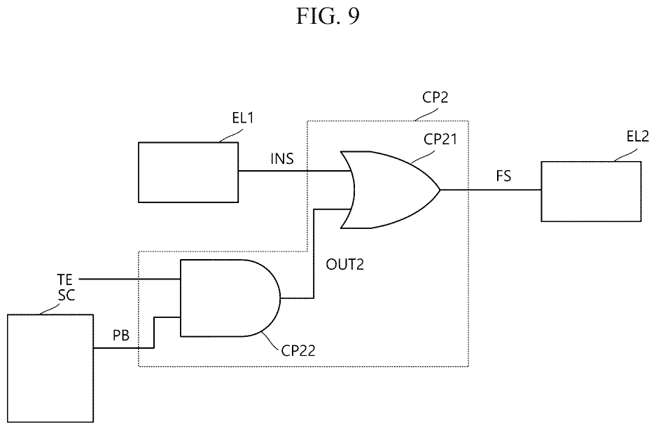

FIGS. 8 and 9 are diagrams illustrating the insertion of conventional control point circuits, according to some example embodiments.

FIGS. 8 and 9 are diagrams illustrating examples of an AND gate-based control point circuit CP1 and an OR gate-based control point circuit CP2, respectively, according to some example embodiments.

Referring to FIGS. 8 and 9, the AND gate-based control point circuit CP1 may be connected to a scan cell SC, and thus may be driven by the scan cell SC, through a NAND gate CP12, while the OR gate-based control point circuit CP2 may be connected to a scan cell SC, and thus driven by the scan cell SC, through an AND gate CP22.

The control point circuit connected to a specific node may be required to be activated in addition to the input of the test enable signal to forcibly apply a fixed logic value to a specific node of the CUT 200.

For example, when a logic high test enable signal TE of FIG. 8 may be input and the control point circuit CP1 is activated by the output (e.g., PB) of the scan cell SC, an internal signal INS output from a first element EL1 of the CUT 200 may be blocked.

Similarly, when the logic high test enable signal TE of FIG. 9 is input and the control point circuit CP2 is activated by the output (e.g., PB) of the scan cell SC, the internal signal INS output from the first element EL1 of the CUT 200 may be blocked.

Referring to FIG. 8, when the output (PB) of the scan cell SC is set to logic “1,” the control point circuit CP1 may inject a logic value “0” into a second element EL2 of the CUT 200.

Similarly, referring to FIG. 9, when the output (PB) of the scan cell SC is set to logic “1”, the control point circuit CP2 may inject a logic value “1” into the second element EL2 of the CUT 200.

Referring to FIGS. 8 and 9, the control point circuits CP1 and CP2 according to the related art are required to be coupled to the scan cell SC, and therefore are not configured to share at least one shared element (SE) with a weight applying circuit according to the related art disposed between the phase shifter and the scan chain and furthermore are not configured to operate (e.g., to selectively transmit a signal FS to the second element EL2 of the CUT 200) based on an operation performed by a shared element SE (or the output signal of the shared element SE based on performing such operation) where the shared element SE is shared with a weight applying circuit 130 that may apply a weight to an output signal of a scan cell and transmit said weighted output signal to the CUT 200 based on the same operation performed by the shared element SE (or the same output signal of the shared element SE based on performing such operation).

FIGS. 10, 11, 12, and 13 are circuit diagrams of a weight applying circuit and a control point circuit that share one or more elements with each other, according to some example embodiments.

The weight applying circuit of FIGS. 10 to 13 (130A, 130B, 130C, 130D) may apply a weighted test pattern WTP to a CUT 200, and the control point circuit (140A, 140B, 140C, 140D) may block an internal signal INS of the CUT 200 at a specific node and may inject a pre-configured logic value into the specific node. For example, the weight applying circuit of FIGS. 10 to 13 (130A, 130B, 130C, 130D) may transmit a weighted output signal to the CUT 200 (e.g., as a signal transmitted to CUT 200 via line OUT that includes a weighted test pattern WTP as shown in FIGS. 10 to 13) based on applying a weight to an output signal of at least one scan cell (e.g., the output signal TP1 of the weighting scan cell WSC) among the plurality of scan cells based on an operation performed by the at least one shared element SE (e.g., a logical operation performed by the shared element), for example a respective one of shared elements 131A, 131B, 131C, or 131D in FIGS. 10 to 13, and the control point circuit of FIGS. 10 to 13 (140A, 140B, 140C, 140D) may selectively control blocking of an internal signal INS of the CUT 200 (received from first element EL1) and transmitting a pre-configured logic value to the CUT 200 (e.g., as forcible signal FS transmitted to the second element EL2), or transmitting the internal signal INS to the CUT 200 (e.g., transmitted to the second element EL2) without blocking, such that one of the pre-configured logic value (e.g., as signal FS) or the internal signal INS is transmitted to the CUT 200 based on the operation performed by the at least one shared element SE. As shown in FIGS. 10 to 13, the control point circuit 140 (e.g., as one of 140A, 140B, 140C, or 140D) may selectively block the internal signal INS of the CUT 200 and transmit the pre-configured logic value (as forcible signal FS) to the CUT 200 based on the control point circuit 140 operating in a test mode. As shown in FIGS. 10 to 13, the control point circuit 140 (e.g., as one of 140A, 140B, 140C, or 140D) may transfer the internal signal INS of the CUT 200 to the CUT 200 (e.g., to second element EL2) without blocking the internal signal INS, based on the control point circuit 140 operating in a normal mode. The control point circuit 140 and the weight applying circuit 130 may receive the test enable signal TE (e.g., at the shared element SE as shown in FIGS. 10 to 13, although example embodiments are not limited thereto). The control point circuit 140 and the weight applying circuit 130 may operate in a test mode based on the test enable signal TE having a first value, for example where the test enable signal TE has a logic high value (e.g., logic value 1), and the control point circuit 140 and the weight applying circuit 130 may operate in a normal mode based on the test enable signal TE having a second, different value, for example where the test enable signal TE has a logic low value (e.g., logic value 0). As shown in FIGS. 10 to 13, the control point circuit 140 (e.g., as one of 140A, 140B, 140C, or 140D) may electrically block the internal signal INS and apply the pre-configured logic value (e.g., as forcible signal FS) to the CUT 200, based on both (1) at least one output signal received from at least one of the scan cells that is separate from the scan cell having the output signal that is weighted by the weight applying circuit 130 (e.g., second output signal TP2 received from the load scan cell LSC alone or in combination with third output signal TP3 received from second load scan cell LLSC, separate from the first output signal TP1 of the weighting scan cell WSC that is configured to receive the second output signal TP2 of the load scan cell LSC) and further based on the control point circuit 140 operating in a test mode (e.g., based on a value of the test enable signal TE received at the control point circuit 140). Detailed descriptions overlapping with those described above with reference to FIGS. 4-8 are omitted to avoid redundancy.

The weight applying circuits 130A, 130B, 130C, and 130D and the control point circuits 140A, 140B, 140C, and 140D described with reference to FIGS. 10 to 13 are example embodiments of the weight applying circuit 130 and the control point circuit 140, respectively, of FIG. 1. Therefore, example embodiments are not limited to the weight applying circuits 130A, 130B, 130C, and 130D and the control point circuits 140A, 140B, 140C, and 140D of FIGS. 10 to 13, and other structures of weight applying circuits configured to apply a weight to a test pattern and other control point circuits configured to block an internal signal and apply a forcible signal with a specific logic value may be used.

Referring to FIG. 10, the weight applying circuit 130A, which modifies a bit of a test pattern to a logic ‘1’ with a probability of 0.25 as in FIG. 4, and the control point circuit 140A, which applies a logic value “0”, may share a NAND gate 131A with each other, such that the NAND gate 131A is a shared element (SE) that is considered to be included in and/or utilized by each of the weight applying circuit 130A and the control point circuit 140A, and thus is shared by the weight applying circuit 130A and the control point circuit 140A.

Referring to FIG. 10, a weighting scan cell WSC may output a first output signal TP1, and a load scan cell LSC may output a second output signal TP2, where the weighting scan cell WSC may receive the second output signal TP2 of the load scan cell LSC.

In the weight applying circuit 130A, as described with reference to FIG. 4, a NAND gate 131A may receive a test enable signal TE and the second output signal TP2 of the load scan cell LSC, and an AND gate 132A may receive an output signal of the NAND gate 131A and the first output signal TP1 of the weighting scan cell WSC. The weight applying circuit 130A may output a test pattern WTP with the first output signal TP1 weighted.

The control point circuit 140A may share the NAND gate 131A with the weight applying circuit 130A, and an AND gate 141A may receive the NAND gate 131A and an internal signal INS from a first element EL1 of the CUT 200.

The control point circuit 140A may transfer the internal signal INS to a second element EL2 of the CUT 200 without blocking the internal signal INS output from the first element EL1 of the CUT 200 in a normal mode of the processor. In a test mode of the processor, the control point circuit 140A may block the internal signal INS output from the first element EL1 of the CUT 200 and may apply a forcible signal FS with a pre-configured logic value “0” to the second element EL2 of the CUT 200.

Referring to FIG. 11, the weight applying circuit 130B, which modifies a bit of a test pattern to a logic ‘1’ with a probability of 0.75 as in FIG. 5, and the control point circuit 140B, which applies a logic value “1”, may share the AND gate 131B with each other, such that the AND gate 131B is a shared element (SE).

In the weight applying circuit 130B, as described with reference to FIG. 5, the AND gate 131B may receive a test enable signal TE and the second output signal TP2 of the load scan cell LSC, and an OR gate 132B may receive an output signal of the AND gate 131B and the first output signal TP1 of the weighting scan cell WSC. The weight applying circuit 130B may output a test pattern WTP with the first output signal TP1 weighted.

The control point circuit 140B may share the AND gate 131B with the weight applying circuit 130B, and an OR gate 141B may receive the AND gate 131B and an internal signal INS from a first element EL1 of the CUT 200.

The control point circuit 140B may transfer the internal signal INS to a second element EL2 of the CUT 200 without blocking the internal signal INS output from the first element EL1 of the CUT 200 in a normal mode of the processor. In a test mode of the processor, the control point circuit 140B may block the internal signal INS output from the first element EL1 of the CUV and may apply a forcible signal FS with a pre-configured logic value “1” to the second element EL2 of the CUT 200.

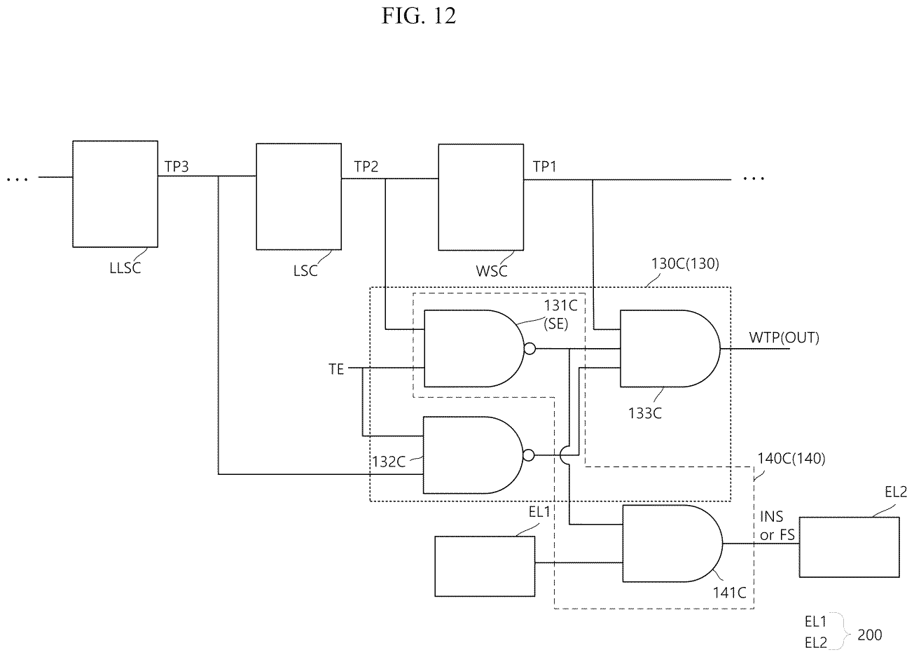

Referring to FIG. 12, the weight applying circuit 130C, modifying a bit of a test pattern to a logic ‘1’ with a probability of 0.125 as in FIG. 6, and the control point circuit 140C, applying a logic value “0,” may share a first NAND gate 131C with each other, such that the first NAND gate 131C is a shared element (SE).

Referring to FIG. 12, a weighting scan cell WSC may output a first output signal TP1, a first load scan cell LSC may output a second output signal TP2, and a second load scan cell LLSC may output a third output signal TP3.

In the weight applying circuit 130C, as described with reference to FIG. 6, a first NAND gate 131C may receive a test enable signal TE and the second output signal TP2 of the first load scan cell LSC, a second NAND gate 132C may receive the test enable signal TE and the third output signal TP3 of the second load scan cell LLSC, and an AND gate 133C may receive output signals of the NAND gates 131C and 132C and the first output signal TP1 of the weighting scan cell WSC. The weight applying circuit 130C may output a test pattern WTP with the first output signal TP1 weighted.

The control point circuit 140C may share the first NAND gate 131C with the weight applying circuit 130C, and an AND gate 141C may receive the output signal of the first NAND gate 131C and an internal signal INS from a first element EL1 of the CUT 200.

The operation of the control point circuit 140C is the same as that of FIGS. 10 and 11.

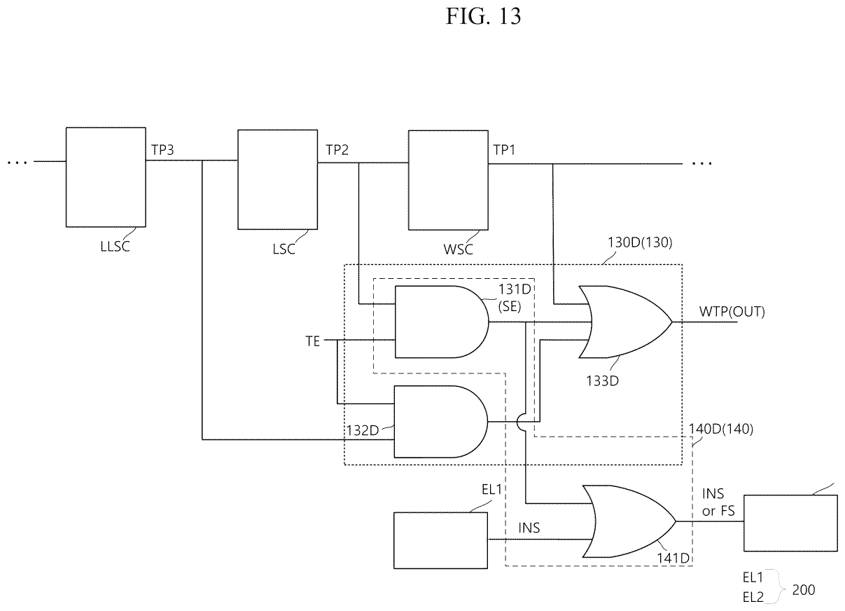

Referring to FIG. 13, the weight applying circuit 130D, modifying a bit of a test pattern to a logic ‘1’ with a probability of 0.875 as in FIG. 7, and the control point circuit 140D, applying a logic value “1,” may share a first AND gate 131D with each other, such that the first AND gate 131D is a shared element (SE).

In the weight applying circuit 130D, as described with reference to FIG. 7, a first AND gate 131D may receive a test enable signal TE and the second output signal TP2 of the first load scan cell LSC, a second AND gate 132D may receive the test enable signal TE and the third output signal TP3 of the second load scan cell LLSC, and an OR gate 133D may receive output signals of the AND gates 131D and 132D and the first output signal TP1 of the weighting scan cell WSC. The weight applying circuit 130D may output a test pattern WTP with the first output signal TP1 weighted.

The control point circuit 140D may share the first AND gate 131D with the weight applying circuit 130D, and an OR gate 141D may receive the output signal of the first AND gate 131D and an internal signal INS from a first element EL1 of the CUT 200.

The operation of the control point circuit 140D is the same as that of FIGS. 10 and 11.

Referring to FIGS. 10-13, the control point circuits 140A, 140B, 140C, and 140D may share a NAND gate or an AND gate of the weight applying circuits 130A, 130B, 130C, and 130D. The weight applying circuits 130A, 130B, 130C, and 130D are coupled to at least one scan cell inside the scan chain, so that the control point circuits 140A, 140B, 140C, and 140D may share some elements with the weight applying circuits 130A, 130B, 130C, and 130D. Accordingly, the processor according to some example embodiments, including the example embodiments of FIGS. 10 to 13, may improve test coverage by the control point circuits 140A, 140B, 140C, and 140D and the weight applying circuits 130A, 130B, 130C, and 130D, respectively, and may not have a significant increase in circuit area by sharing one or more elements (e.g., one or more circuit components, one or more electronic components, etc.) with each other so as to each operate based on using the same shared one or more elements. It will be understood that the shared element SE of the weight applying circuit 130 and the control point circuit 140 may be understood to include a “first element” configured to receive a test enable signal TE such that the weight applying circuit 130 and the control point circuit 140 may operate in a test mode or a normal mode based on the test enable signal TE (e.g., based on a value, logic value, etc. of the test enable signal TE), for example based on an operation (e.g., a logical operation) performed by the first element according to the value of the test enable signal TE. For example, the “first element” may include a logic circuit, logic gate, logic gate device, etc. that is configured to perform a logical operation (e.g., a Boolean function) based on the value of the test enable signal TE so as to generate an output signal, and the weight applying circuit 130 and the control point circuit 140 may operate in a test mode or a normal mode based on the value of the output signal of the “first element” according to the operation performed by the first element.

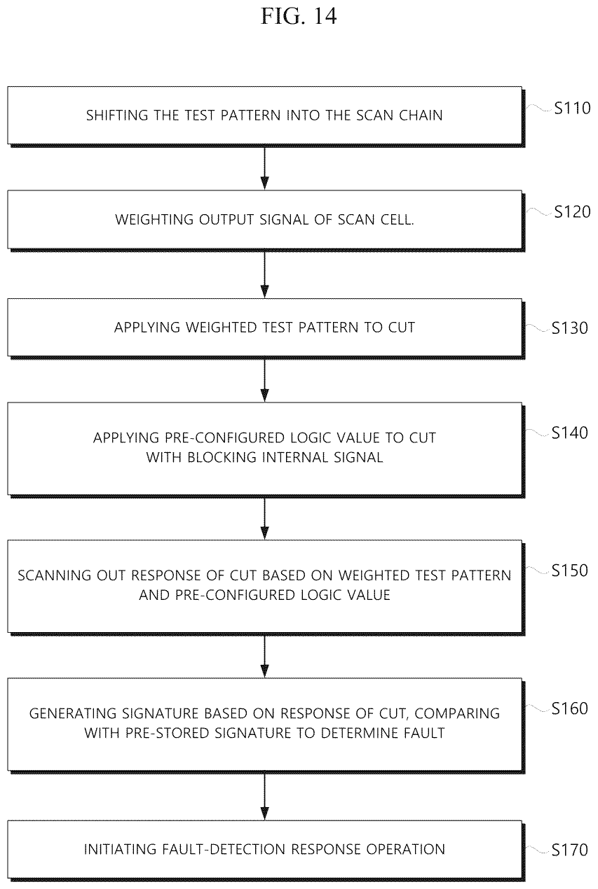

FIG. 14 is a flowchart illustrating a method of operating a processor according to some example embodiments. The operation method of FIG. 14 may be performed in the processor 10 and/or the processor 10A of FIGS. 1 and 2, for example based on operation of the electronic device 2000 in FIG. 20 that may include some or all of the processor 10 and/or the processor 10A. Detailed descriptions overlapping with those described above with reference to FIGS. 1-13 are omitted to avoid redundancy.

In operation S110, the processor may shift a test pattern into a scan chain (e.g., shift-in the test pattern to the scan chain, for example shifting-in a test pattern to a scan chain, the scan chain including a plurality of scan cells connected in a chain) where a plurality of scan cells are connected in a chain.

The test pattern scanned-in to the scan cells may be a pseudo-random test pattern with correlation removed and which may be generated by a pattern generating circuit, and thus operation S110 may include shifting-in a test pattern of pseudo-random numbers to a scan chain, the scan chain including a plurality of scan cells connected in a chain.

In a scan-in mode, bits of the test pattern may be sequentially shifted-in through each of the scan cells toward the inside of the scan chain. A scan cell may include a flip-flop or a latch, and the scan-in test pattern may complete the shift inside the scan chain and may be stored in each of the scan cells.

In operations S120 and S130, the processor may apply the test pattern to the circuit-under-test. In operation S120, the processor may apply a weight to an output signal of at least one scan cell among the plurality of scan cells.

At least some bits of the scan-in test pattern may be weighted by the weight applying circuit 130 of FIG. 1. For example, the weight applying circuit may operate in a test mode based on a test enable signal. The logic value of at least one bit position of the test pattern may be changed by the weight applying circuit 130. The probability that the logic value is to be changed to “1” may be based on the structure of the weight applying circuit 130. The weight applying circuit 130 may be in a form where the weight applying circuits 130A, 130B, 130C, and 130D of FIGS. 4 to 7 share at least one element with a control point circuit. The processor may apply the weight to the output signal of the at least one scan cell based on an operation (e.g., a logical operation) performed by at least one shared element that is shared between the weight applying circuit and the control point circuit of the processor (e.g., based on a value of an output signal of the shared element based on the shared element performing the operation).

The plurality of weight applying circuits may change the bits of the test pattern of each of the coupled plurality of scan cells. The structures of the plurality of weight applying circuits connected to each of the plurality of scan cells may be different from each other. The plurality of weight applying circuits connected to each of the plurality of scan cells may change the bits of the test pattern to a logic value “1” with different probabilities.

In operation S130, the processor may transmit (e.g., apply) the weighted test pattern to the CUT.

A test pattern of a scan cell to which no weight applying circuit is coupled may be directly applied to a coupled logic circuit of the CUT in operation S130. A test pattern of a scan cell to which a weight applying circuit is coupled may be “weighted” to be changed to a logic value “1” with a pre-configured probability by the weight applying circuit to thereby form a weighted test pattern, and then the weight applying circuit may apply the weighted test pattern to a coupled logic circuit of the CUT. The weight applying circuit may operate the shared element SE to perform the weighting of the test pattern.

In operation S140, a control point circuit of the processor that shares the at least one shared element (SE) with the weight applying circuit may block an internal signal of the CUT and may apply a pre-configured logic value to the CUT.

The control point circuit may apply a pre-configured logic value to a control point node based on a test pattern of a coupled scan cell and a test enable signal. An internal signal of the CUT input to the control point node may be blocked. The control point circuit may selectively block the internal signal of the circuit-under-test and transmit (e.g., apply) the pre-configured logic value to the CUT based on the same operation (e.g., logical operation) performed by at least one shared element that is shared between the weight applying circuit and the control point circuit of the processor and upon which the applying of the weighted test pattern by the weight applying circuit to the CUT is based (e.g., based on the value of the output signal of the shared element based on the shared element performing the same operation used for the applying of the weighted test pattern).

The control point circuit may share at least one element (referred to herein as a shared element SE) with the weight applying circuit. For example, the control point circuit may share a NAND gate or an AND gate with the weight applying circuit. An element of the weight applying circuit shared with the control point circuit may receive a test enable signal TE. The control point circuit and the weight applying circuit may operate in a test mode based on the test enable signal (e.g., based on the test enable signal having a first value, for example a logic high value). The control point circuit and the weight applying circuit may operate in a normal mode based on the test enable signal (e.g., based on the test enable signal having a different, second value, for example a logic low value). In a normal mode, the control point circuit may transfer an internal signal INS to a logic circuit of the CUT connected to an output terminal (e.g., to element EL2) without blocking the internal signal INS of the CUT.

In operation S150, the processor may capture a test response to the circuit-under-test based on the applied test pattern (e.g., based on the weighted test pattern) and shift-out the test response to the scan chain. For example operation S150 may include scanning-out a response of the CUT based on the weighted test pattern and the pre-configured logic value. For example, in operation S150, the processor may scan-out a response of the CUT where the response (e.g., the test response) is generated at the CUT based on the weighted test pattern and the pre-configured logic value transmitted (e.g., applied) thereto.

Accordingly, it will be understood that the weight applying circuit may transmit a weighted test pattern to a circuit-under-test based on applying a weight to an output signal of at least one scan cell among the plurality of scan cells, based on an operation performed by at least one shared element, and the control point circuit sharing the at least one shared element with the weight applying circuit, may block (e.g., selectively block) an internal signal of the circuit-under-test and apply a pre-configured logic value to the circuit-under-test, based on the operation of at least one shared element. For example, the weight applying circuit may apply the weight to the output signal of the at least one scan cell based on a test enable signal (e.g., a value thereof) received at the at least one shared element, and the control point circuit may block (e.g., selectively block) the internal signal and apply the pre-configured logic value to the circuit-under-test based on the same test enable signal (e.g., the value thereof) received at the at least one shared element.

The CUT may store a test response based on the weighted test pattern and the forcible signal with the pre-configured logic value injected by the control point circuit in the scan cells. Each bit of the test response stored in the scan cells may be sequentially shifted toward the outside of the scan chains. The scanned-out test response may be input (transmitted) to the MISR 160 of FIG. 2.

At S160, the processor (e.g., the MISR 160) may process the test response to generate a signature signal, or “signature” (e.g., MISR_SCAN_OUT), and the processor may compare the signature signal with a pre-stored signature signal (e.g., stored in memory 2030 of electronic device 2000 and loaded therefrom) to determine whether a fault of the CUT has occurred. For example, the processor may determine that a fault of the CUT has occurred in response to a determination that the generated signature signal does not match (e.g., is not identical to) the pre-stored signature signal.

At S170, the processor may initiate and/or perform a fault-detection response operation in response to determining the fault of the CUT 200 at S160. Such a fault-detection response operation may include, for example initiating a reset, shutdown, bypass, and/or a repair of the CUT or any portion thereof (e.g., including resetting the program of instructions executed to operate some or all of the CUT) to adjust operation of the CUT 200 to repair or bypass the determined fault, transmitting a warning signal (e.g., to a user interface coupled to the processor 10, to an electronic device communicatively coupled with the processor 10, or the like) indicating the determination of the fault, any combination thereof, or the like.

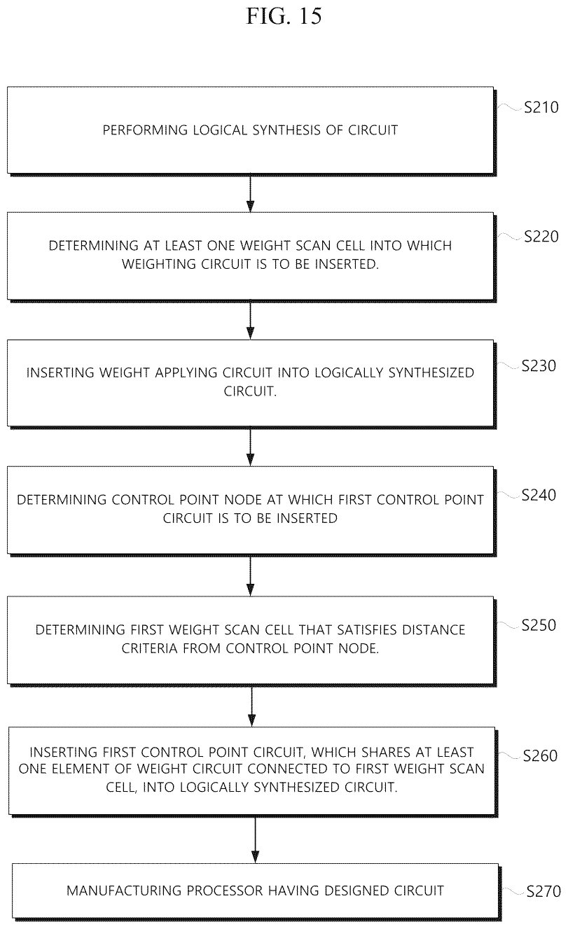

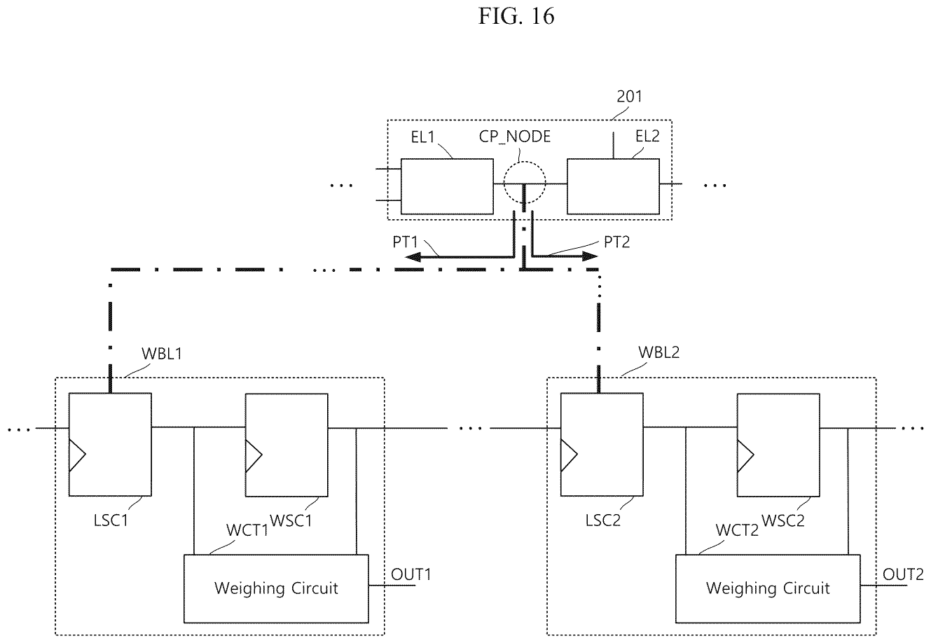

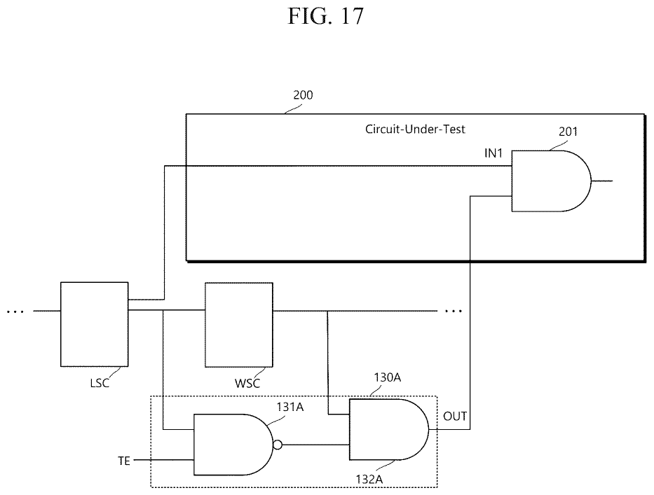

FIG. 15 is a flowchart illustrating a method of designing a processor according to some example embodiments. FIG. 16 is a diagram illustrating selection of a weighting scan cell that satisfies a pre-configured distance criterion with a control point node into which a first control point circuit is to be inserted, according to some example embodiments.

The method of designing a processor described with reference to FIG. 15 may be performed in a circuit design device, and thus the method shown in FIG. 15 may be implemented based on operation of a circuit design device, for example based on operation of the electronic device 2000 in FIG. 20 that includes and/or implements the circuit device. The method for designing a processor may be performed as a portion of an electronic design automation (EDA) tool of the circuit design device (which may be implemented based on operation of the electronic device 2000, for example based on operation of a processing circuitry 2020 thereof to execute a program of instructions stored in a memory 2030 thereof). The method of designing a processor may be performed by the circuit design device based on software instructions stored on a computer-readable medium (e.g., in memory 2030), software instructions executed on a computer, or a combination of both. The method of designing a processor may be executed on a single computer or a networked computer. The circuit design device may be a general-purpose computing device with an EDA tool installed, or a dedicated computing device that exclusively performs EDA, either of which may be implemented by electronic device 2000. The circuit design device may be a server computing device or a personal computing device, any of which may be implemented by electronic device 2000. At least some operations of the method of designing a processor may be performed automatically in the EDA tool of the circuit design device in response to user input.

In operation S210, the circuit design device may perform logical synthesis of a circuit (e.g., may logically synthesize the circuit). The circuit in which logical synthesis is performed may be a circuit implemented with register-transfer-level (RTL) code.

In operation S220, the circuit design device may determine at least one weighting scan cell into which a weight applying circuit is to be inserted in the logically synthesized circuit.

The circuit design device may analyze deterministic patterns generated by an automatic test pattern generator (ATPG) of a semiconductor automatic test equipment based on the logically synthesized circuit to determine the at least one weighting scan cell into which the weight applying circuit is to be inserted, in the logically synthesized circuit.

In some example embodiments, the circuit design device may calculate a specified bit ratio and a weight value of the deterministic patterns.

In some example embodiments, the circuit design device may determine at least one weighting scan cell into which a weight applying circuit is to be inserted, based on the specified bit ratio and the weight. For example, a scan cell corresponding to a bit with a high specified bit ratio and/or a high weight among the deterministic patterns may be determined as a weighting scan cell. The circuit design device may determine at least one weighting scan cell.

In operation S230, the circuit design device may insert a weight applying circuit into the logically synthesized circuit (e.g., into the design of the logically synthesized circuit) based on the determined at least one weighting scan cell that is determined at S220.

The circuit design device may insert one of a plurality of weight applying circuits with different structures into the logically synthesized circuit so that it is coupled to the weighting scan cell. The coupled weight applying circuit is a circuit that may apply a weight corresponding to the weighting scan cell. The circuit design device may insert a weight applying circuit into the logically synthesized circuit to be suitable for a weight corresponding to each weighting scan cell.

In some example embodiments, based on the weights of the weighting scan cells, the weighting scan cells may be divided into a plurality of groups by a certain range of weights. The circuit design device may insert a different weight applying circuit for each group into the logically synthesized circuit. For example, weighting scan cells of different groups may be coupled to weight applying circuits of different structures, and weighting scan cells of the same group may be coupled to a weight applying circuit of the same structure.

In operation S240, the circuit design device may determine a first control point node (e.g., in the design of the logically synthesized circuit) into which a first control point circuit is to be inserted, based on the logically synthesized circuit.

The circuit design device may use various known test point insertion (TPI) techniques to determine the control point node to be inserted.

A general TPI technique may include the determination of a control point node and the determination of an observation point node.

The TPI technique may be used to determine a control point node that improves the defect detectability of a logic circuit. The determination of an optimal test point node for a test point circuit to be inserted is an NP-complete problem. Various conventional methods have been proposed to determine an appropriate test point node, and embodiments are not limited to a specific TPI technique.

In operation S250, the circuit design device may determine a first weighting scan cell, among the at least one weighting scan cell determined at S220, that satisfies a pre-configured distance criterion with respect to the first control point node into which the first control point circuit is to be inserted.

In some example embodiments, the circuit design device may analyze the topology of the logically synthesized circuit and may determine the first weighting scan cell closest to the first control point node based on the topology.

For example, referring to FIG. 16, a first control point node CP_NODE may be determined as a node between a first element EL1 and a second element EL2 of the CUT. A first weighting circuit block WBL1 applies a weight to an output signal of a first weighting scan cell WSC1 with a first weight applying circuit WCT1 and then applies it to the CUT OUT1, and a second weighting circuit block WBL2 applies a weight to an output signal of a second weighting scan cell WSC2 with a second weight applying circuit WCT2 and then applies it to the CUT OUT2. The circuit design device may compare the length of a path PT1 based on the topology of the first control point node CP_NODE and the first weighting scan cell WSC1 with the length of a path PT2 based on the topology of the second weighting scan cell WSC2, and then may select the weighting scan cell with the shorter length.

In some example embodiments, the length of a path based on the topology may be based on the number of elements disposed on the path.

In operation S260, the circuit design device may insert a first control point circuit that shares some elements (e.g., one or more shared elements SE) of a weight applying circuit connected to the first weighting scan cell into the logically synthesized circuit (e.g., insert the first control point circuit into the design of the logically synthesized circuit). For example, a first control point circuit that shares some elements of the weight applying circuit may be inserted as in some example embodiments, for example as in the example embodiments shown in any of FIGS. 10 to 13. For example, the inserting at operation S260 may include inserting a first control point circuit, sharing a NAND gate or a first AND gate of the weight applying circuit, into the logically synthesized circuit (e.g., into the design thereof). The insertion may include inserting the first control point circuit into the logically synthesized circuit (e.g., into the design thereof) to cause a second AND gate or an OR gate of the first control point circuit to be configured to receive an output signal of the NAND gate or the first AND gate of the weight applying circuit.

In some example embodiments, after performing operation S230 and operation S260, the circuit design device may check re-convergence caused by the insertion of the weight applying circuit or the control point circuit.

At S270, the circuit design device may cause a processor having the design of the logically synthesized circuit to be manufactured, based on control of known processor manufacturing equipment (e.g., based on transmitting the design of the logically synthesized circuit to manufacturing control device that may be implemented by an electronic device 2000 as shown in FIG. 20, where the manufacturing control device may control known manufacturing equipment to manufacture a processor having the design of the logically synthetized circuit, for example a processor 10 as shown in FIG. 1, a processor 10A as shown in FIG. 2, or the like, and/or any device including same (e.g., an electronic device 2000 as shown in FIG. 20). In some example embodiments, the circuit design device may implement the manufacturing control device and therefore may control known manufacturing equipment to manufacture a processor having the design of the logically synthetized circuit, where, as shown in view of FIGS. 1 to 14, said processor may be configured to exhibit reduced size or area without compromising the ability of the processor to detect faults of a CUT and, in some example embodiments, perform an operation in response to detection of such fault, for example where the configuration of the processor to exhibit reduced size or area without compromising the ability of the processor to detect faults may be based on the processor including a weight applying circuit and a control point circuit that share at least one shared element and are configured to perform their respective operations based on the operation of the at least one shared element (e.g., a logical operation, the output of which may be an input to respective logical devices of the weight applying circuit and the control point circuit).

In some example embodiments, the circuit design device may analyze the association between another input signal of an element that receives an output signal of the control point circuit and an output signal of a load scan cell coupled to the weight applying circuit coupled to the control point circuit. In the present specification, the case in which the association is high may be referred to as re-convergence of output signals.

FIG. 17 is a diagram illustrating re-convergence of output signals due to the insertion of a weight applying circuit, according to some example embodiments. Re-convergence caused by the insertion of a control point circuit may also be performed as in a method of designing a processor according to some example embodiments, including the example embodiments of FIG. 15.

Referring to FIG. 17, the circuit design device may check an element 201 of the CUT 200 that receives an output signal OUT of the weight applying circuit 130A. The circuit design device may check an element that transmits another input signal IN1 received by the element 201 of the CUT 200. When the element that transmits the input signal IN1 is a load scan cell LSC within a pre-configured criterion of the weighting scan cell WSC, the circuit design device may not couple the weight applying circuit 130A to the corresponding weighting scan cell WSC.

Similarly, when the output signal of a load scan cell LSC to which a control point circuit is coupled is transmitted to an element to which a forcible signal output by the control point circuit is input, the circuit design device may remove the first control point circuit from the logically synthesized circuit. The circuit design device may change the weight applying circuit to which the first control point circuit will be coupled. The circuit design device may determine a second weighting scan cell that satisfies the pre-configured distance criterion among the weighting scan cells connected to the plurality of weight applying circuits. The circuit design device may insert a second control point circuit, sharing some elements of the weight applying circuit connected to the second weighting scan cell, into the logically synthesized circuit.

For example, the circuit design device may analyze a correlation between input signals of an element receiving a second output signal of the first control point circuit and a first output signal of a first load scan cell providing an output signal to the first weighting scan cell; determine a second weighting scan cell satisfying the distance criterion with respect to the control point node, among the at least one weighting scan cell, based on the correlation; remove the first control point circuit from the logically synthesized circuit (e.g., from the design thereof); and insert a second control point circuit, sharing one or more elements with the weight applying circuit connected to the second weighting scan cell, into the logically synthesized circuit (e.g., into the design thereof).

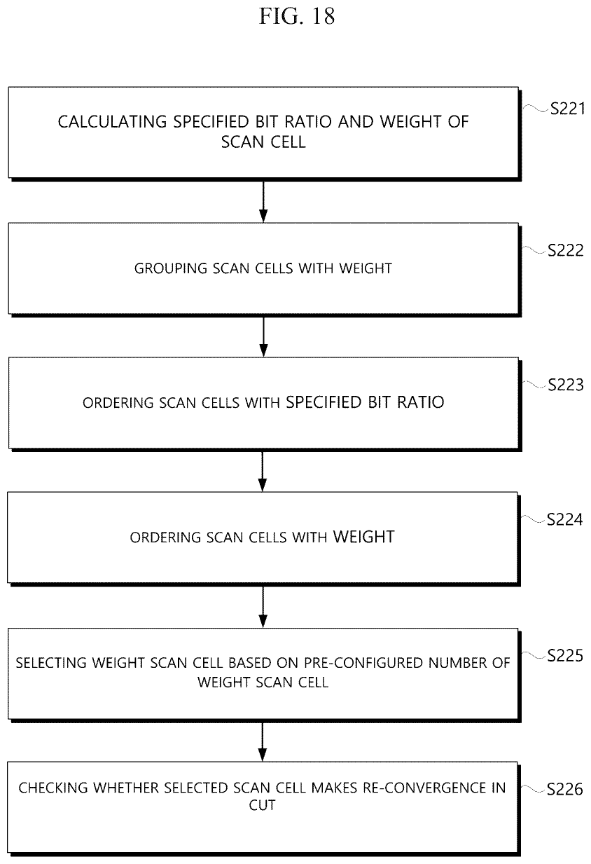

FIG. 18 is a flowchart illustrating a method of determining a weighting scan cell into which a weight applying circuit is to be inserted, according to some example embodiments.

The method of determining a weighting scan cell of FIG. 18 may be performed in operation S220 of FIG. 15.

In operation S221, the circuit design device may calculate a specified bit ratio and a weight for each scan cell based on a deterministic pattern.

Each bit position of the deterministic pattern may correspond to each scan cell.

In some example embodiments, the circuit design device may calculate the specified bit ratio by dividing the number of care bits, which are bits having a logic “0” or a logic “1” among the bits at the same bit position of the deterministic patterns, by the total number of deterministic patterns.

In some example embodiments, the circuit design device may calculate the weight as the ratio of the care bits having a pre-configured logic value among the bits at the same bit position of the deterministic patterns.

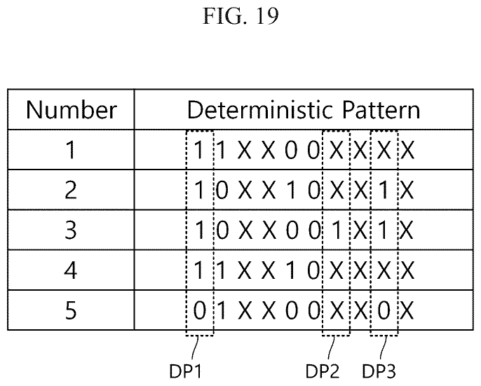

FIG. 19 illustrates an automatic test pattern generator (ATPG) deriving five deterministic patterns, according to some example embodiments.

Referring to FIG. 19, the first bit position DP1 of the deterministic patterns includes 5 care bits, of which 4 are logic “1” and 1 is logic “0.” The specified bit ratio of the scan cell corresponding to the first bit position of the deterministic patterns may be calculated as 1, which is the ratio of the 5 care bits to the total number of deterministic patterns, which is 5. The weight of the scan cell corresponding to the first bit position of the deterministic patterns may be calculated as 0.8, which is the ratio of the 4 logic “1” care bits to the 5 care bits.

Similarly, the second bit position DP2 of the deterministic patterns includes one care bit, of which one is logic “1” and zero is logic “0.” Accordingly, the specified bit ratio of the scan cell corresponding to the second bit position of the deterministic patterns is 1/5=0.2, and the weight is 1/1=1. The third bit position DP3 of the deterministic patterns may include 3 care bits, of which 2 are logic “1” and 1 is logic “0.” Therefore, the specified bit ratio of the scan cell corresponding to the third bit position of the deterministic patterns is 3/5=0.6, and the weight is 2/3=0.67.

In some example embodiments, the circuit design device may select a scan cell to which a weight applying circuit is to be coupled from among the scan cells whose specified bit ratio is greater than or equal to a pre-configured criterion. Accordingly, the determining of the control point node into which the first control point circuit is to be inserted at S220 may include selecting at least one scan cell in the deterministic pattern in which a ratio of care bits is greater than or equal to a pre-configured criterion.

In operation S222, the scan cells may be grouped based on the weight. For example, operation S222 may include grouping scan cells based on a ratio of bits having a pre-configured logic value, among care bits of the deterministic patterns. The circuit design device may divide the scan cells into a plurality of groups by a certain range of weights. For example, scan cells with a weight of 0.125 or less may be grouped as Group 1, scan cells with a weight greater than 0.125 and less than or equal to 0.375 may be grouped as Group 2, scan cells with a weight of 0.625 or more and less than 0.875 may be grouped as Group 3, and scan cells with a weight of 0.875 or more may be grouped as Group 4.

In some example embodiments, when a finally determined weighting scan cell belongs to Group 1, the circuit design device may couple the weight applying circuit of FIG. 6 to the weighting scan cell. Similarly, when a weighting scan cell belongs to Group 2, Group 3, and Group 4, respectively, the circuit design device may couple the weight applying circuit of FIG. 4, the weight applying circuit of FIG. 5, and the weight applying circuit of FIG. 7 to the scan cells of each group, respectively.

In operation S223, the circuit design device may order the scan cells in each group in descending order of their specified bit ratio. In some example embodiments, the circuit design device may select a pre-configured number of scan cells from each group as candidate scan cells. For example, the circuit design device may select a candidate set of scan cells, which is a certain multiple of the number of weighting scan cells to be finally selected, in descending order of their specific bit rate.

In operation S224, the circuit design device may order the candidate scan cells in descending order of their weight.

In operation S225, the circuit design device may select and determine as weighting scan cells a number of candidate scan cells equal to the number of weighting scan cells to be finally selected, in descending order of their weight.

In operation S226, as described with reference to FIG. 16, the circuit design device may check whether re-convergence occurs when the weight applying circuit is coupled to the weighting scan cell. When re-convergence occurs, the circuit design device may exclude the scan cell that caused the re-convergence, select the next candidate scan cell, and check again whether re-convergence occurs. The circuit design device may repeat operation S226 until weighting scan cells that do not cause re-convergence are selected.

In some example embodiments, when determining a weighting scan cell that satisfies the distance criterion with the control point node, the circuit design device may search for the weighting scan cell that satisfies the distance criterion only from among the scan cells belonging to a specific group. Accordingly, the circuit design device may select a particular scan cell satisfying the distance criterion only in the scan cells of a selected group, among the grouped scan cells, as a first weighting scan cell.

For example, when determining a weighting scan cell to which the control point circuits 140A and 140C of FIGS. 10 and 12 are to be coupled, the circuit design device may search for the weighting scan cell from among the scan cells of the group (e.g., a particular weighting scan cell) that includes a NAND gate and select same as the first weighting scan cell. For example, the circuit design device may search for a weighting scan cell from among the weight applying circuits corresponding to FIGS. 4 and 6. Similarly, when determining a weighting scan cell to which the control point circuits 140B and 140D of FIGS. 11 and 13 are to be coupled, the circuit design device may search for the weighting scan cell from among the scan cells of the group that includes an AND gate. For example, the circuit design device may search for a weighting scan cell from among the weight applying circuits corresponding to FIGS. 5 and 7.

The method of determining a weighting scan cell of FIG. 18 is an example based on an implementation, and a weighting scan cell may be determined by other methods. In addition, the present invention may determine a weighting scan cell using criteria other than the specified bit ratio and the weight of the scan cell.

FIG. 20 is a schematic view illustrating an electronic device according to some example embodiments. The electronic device 2000 may include and/or implement the processor according to some example embodiments (e.g., the processor 10, the processor 10A, etc.) the BIST circuit 100 according to some example embodiments, the CUT 200 according to some example embodiments, the circuit design device according to some example embodiments, a manufacturing control device according to some example embodiments, any combination thereof, or the like.

Referring to FIG. 20, the electronic device 2000 may include a bus 2010, processing circuitry 2020, and a memory 2030. Information of the processing circuitry 2020 and/or memory 2030 may be transmitted to each other through the bus 2010.

The processing circuitry 2020 may include circuitry such as a hardware including logic circuits; a hardware/software combination such as processor-implemented software; or any combination thereof. For example, the processing circuitry 2020 may include a central processing unit (CPU), an arithmetic logic unit (ALU), a digital signal processor, a microcomputer, a field programmable gate array (FPGA), System-on-Chip (SoC), a programmable logic unit, a microprocessor, an application-specific integrated circuit (ASIC), and the like. As an example, the processing circuitry may include a non-transitory computer readable storage device.

The memory 2030 may store an instruction program, and the processing circuitry 2020 may perform a function, including for example any of the methods as shown in any of the example embodiments, including for example the method shown in at least FIG. 15, based on executing the stored instruction program. For example, the electronic device 2000 may be a circuit design device and may perform the method shown in FIGS. 15 and/or 19 based on the processing circuitry 2020 executing a program of instructions stored in the memory 2030. In another example, the electronic device 2000 may be a processor 10, 10A, etc. and may perform the method shown in FIG. 14 based on the processing circuitry 2020 executing a program of instructions stored in the memory 2030.

The units and/or modules described herein may be implemented using hardware constituent elements and software constituent elements. For example, the hardware constituent elements may include microphones, amplifiers, band pass filters, audio-to-digital converters, and processing devices. The processing device may be implemented using one or more hardware devices configured to perform and/or execute program code by performing arithmetic, logic, and input/output operations. The processing device may include a processor, a controller and an arithmetic logic unit, a digital signal processor, a microcomputer, a field programmable array, a programmable logic unit, a microprocessor, or any other device capable of responding to and executing instructions. The processing device may access, store, operate, process, and generate data in response to execution of an operating system (OS) and one or more software running on the operating system.

The software may include a computer program, a code, an instruction, or any combination thereof, and may transform a processing device for a special purpose by instructing and/or configuring the processing device independently or collectively to operate as desired. The software and data may be implemented permanently or temporarily as signal waves capable of providing or interpreting instructions or data to machines, parts, physical or virtual equipment, computer storage media or devices, or processing devices. The software may also be distributed over networked computer systems so that the software may be stored and executed in a distributed manner. The software and data may be stored by one or more non-transitory computer readable storage devices.

A method according to the foregoing example embodiments may be recorded in a non-transitory computer readable storage device including program instructions for implementing various operations of the aforementioned example embodiments. The storage device may also include program instructions, data files, data structures, and the like alone or in combination. The program instructions recorded in the storage device may be specially designed for some example embodiments or may be known to those skilled in computer software and available for use. Examples of non-transitory computer-readable storage devices may include magnetic media such as hard disks, floppy disks, and magnetic tapes; optical media such as CD-ROM discs, DVDs and/or blue-ray discs; magneto-optical media such as optical disks; and a hardware device configured to store and execute program instructions such as ROM, RAM, flash memory, and the like. The aforementioned device may be configured to operate as one or more software modules to perform the operations of the aforementioned example embodiments.

As set forth above, according to some example embodiments, the test coverage of a built-in self-test (BIST) circuit may be improved using additional circuitry of a significantly smaller area. As a result, the size of the BIST circuit may be reduced without compromising detection performance of the BIST circuit.

In addition, the reliability of a processor may be improved.

As described herein, any devices, systems, modules, portions, units, controllers, circuits, and/or portions thereof according to any of the example embodiments, and/or any portions thereof (including, without limitation, the processor 10, the BIST circuit 100, the pattern generating circuit 110, the scan chain 120, the weight applying circuit 130, the control point circuit 140, the compacting circuit 150, the CUT 200, the processor 10A, the pseudo-random pattern generator 110A, the LFSR 111, the phase shifter 113, the scan chains 120_1 to 120_n, the MISR 160, the scan cells SC1 to SCN, the LSC, the WSC, the LLSC, the weight applying circuit 130A, the weight applying circuit 130B, the weight applying circuit 130C, the weight applying circuit 130D, the first element EL1, the second element EL2, the scan cell SC, the CP1, the CP2, the control point circuit 140A, the control point circuit 140B, the control point circuit 140C, the control point circuit 140D, the element 201 of the CUT 200, the WBL1, the WBL2, the circuit design device, the electronic device 2000, the processing circuitry 2020, the memory 2030, any portion thereof, or the like) may include, may be included in, and/or may be implemented by one or more instances of processing circuitry such as hardware including logic circuits; a hardware/software combination such as a processor executing software; or a combination thereof. For example, the processing circuitry more specifically may include, but is not limited to, a central processing unit (CPU), an arithmetic logic unit (ALU), a graphics processing unit (GPU), an application processor (AP), a digital signal processor (DSP), a microcomputer, a field programmable gate array (FPGA), and programmable logic unit, a microprocessor, application-specific integrated circuit (ASIC), a neural network processing unit (NPU), an Electronic Control Unit (ECU), an Image Signal Processor (ISP), and the like. In some example embodiments, the processing circuitry may include a non-transitory computer readable storage device (e.g., a memory), for example a solid state drive (SSD), storing a program of instructions, and a processor (e.g., CPU) configured to execute the program of instructions to implement the functionality and/or methods performed by some or all of any devices, systems, modules, portions, units, controllers, circuits, and/or portions thereof according to any of the example embodiments.

In some example embodiments, a method of operating a processor may include: transmitting a test pattern of pseudo-random numbers; scanning-in the test pattern to a plurality of scan cells connected in a chain in a scan chain; and scanning-out a test response of a circuit-under-test based on the test pattern, the plurality of scan cells coupled to at least one logic circuit of the circuit-under-test. The method may further include operating a weight applying circuit and a control point circuit that are configured to share at least one shared element. The operating of the weight applying circuit may include transmitting, at the weight applying circuit, a weighted output signal to the circuit-under-test based on applying a weight to an output signal of at least one scan cell among the plurality of scan cells based on an operation performed by the at least one shared element. The operating of the control point circuit may include selectively controlling, at the control point circuit, blocking of an internal signal of the circuit-under-test and transmitting a pre-configured logic value to the circuit-under-test or transmitting the internal signal to the circuit-under-test without blocking, such that one of the pre-configured logic value or the internal signal is transmitted to the circuit-under-test based on the operation performed by the at least one shared element; and transmitting a signature generated based on compacting the test response of the circuit-under test.

The method may include, receiving the output signal of the at least one scan cell at the weight applying circuit, applying the weight at the weight applying circuit to the output signal to generate the weighted output signal, and transmitting the weighted output signal from the weight applying circuit to the circuit-under-test. The weight applying circuit may perform the applying and the transmitting based on the operation performed by the at least one shared element.

The method may include blocking, at the control point circuit, the internal signal of the circuit-under-test and transmitting the pre-configured logic value to the circuit-under-test, based on the control point circuit operating in a test mode.

The method may include transferring, at the control point circuit, the internal signal of the circuit-under-test to the circuit-under-test without blocking the internal signal, based on the control point circuit operating in a normal mode.

The method may include receiving, at the control point circuit as input signals, a first output signal of the at least one scan cell and a second output signal of at least one separate scan cell among the plurality of scan cells of the scan chain.

The method may include receiving, at the control point circuit as part of the input signals, second output signals of at least two scan cells among the plurality of scan cells of the scan chain, the second output signals including the second output signal of the at least one separate scan cell.
The method may include receiving, at the weight applying circuit, the first output signal of a first scan cell among the plurality of scan cells and the second output signal of a second scan cell among the plurality of scan cells; and applying, at the weight applying circuit, the weight to the first output signal of the first scan cell to generate the weighted output signal. The method may include receiving, at the control point circuit, the second output signal of the second scan cell, receiving a test enable signal, at the control point circuit, receiving the internal signal from the circuit-under-test at the control point circuit, and selectively blocking, at the control point circuit, the internal signal and applying the pre-configured logic value to the circuit-under-test, based on both the second output signal and the control point circuit operating in a test mode. The first scan cell may receive the second output signal of the second scan cell.
The method may include shifting-in the test pattern to the scan chain, applying the test pattern to the circuit-under-test, capturing the test response of the circuit-under-test, and shifting-out the test response to the scan chain.
The at least one shared element may include a first element configured to receive a test enable signal; and the weight applying circuit and the control point circuit may operate in a test mode based on the test enable signal.
The plurality of scan cells may include a first scan cell configured to transmit a first output signal and a second scan cell configured to transmit a second output signal; the weight applying circuit may apply the weight to the first output signal of the first scan cell to generate the weighted output signal; and the first scan cell and the first element may receive the second output signal.
In some example embodiments, a processor may include a memory storing a program of instructions and processing circuitry configured to execute the program of instructions to: shift-in a test pattern of pseudo-random numbers to a scan chain, the scan chain including a plurality of scan cells connected in a chain, the test pattern of the pseudo-random numbers being generated by a pattern generating circuit; transmit a weighted test pattern to a circuit-under-test based on applying, by a weight applying circuit, a weight to an output signal of at least one scan cell among the plurality of scan cells, based on an operation performed by at least one shared element; block, by a control point circuit sharing the at least one shared element with the weight applying circuit, an internal signal of the circuit-under-test and applying a pre-configured logic value to the circuit-under-test, based on the operation of the at least one shared element; and scan-out a response of the circuit-under-test based on the weighted test pattern and the pre-configured logic value.
The processing circuitry may be further configured to execute the program of instructions to: apply, by the weight applying circuit, the weight to the output signal of the at least one scan cell based on a test enable signal received at the at least one shared element; and block, by the control point circuit, the internal signal and applying the pre-configured logic value to the circuit-under-test based on the test enable signal.
In some example embodiments, a circuit design device may include a memory storing a program of instructions and processing circuitry configured to execute the program of instructions to perform a method of designing a processor, the method comprising: logically synthesizing a circuit to generate a logically synthesized circuit; analyzing deterministic patterns generated by an automatic test pattern generator based on the logically synthesized circuit to determine at least one weighting scan cell, into which a weight applying circuit is to be inserted, in the logically synthesized circuit; inserting the weight applying circuit into the logically synthesized circuit based on the at least one weighting scan cell; determining a control point node into which a first control point circuit is to be inserted, based on the logically synthesized circuit; determining a first weighting scan cell among the at least one weighting scan cell that satisfies a distance criterion with respect to the control point node; and inserting the first control point circuit, sharing one or more elements with the weight applying circuit connected to the first weighting scan cell, into the logically synthesized circuit.

The determining of the control point node into which the first control point circuit is to be inserted may include: selecting at least one scan cell in a deterministic pattern of the deterministic patterns in which a ratio of care bits is greater than or equal to a pre-configured criterion.
The method may include grouping scan cells based on a ratio of bits having a pre-configured logic value, among care bits of the deterministic patterns.
The determining of the first weighting scan cell may include selecting a particular scan cell satisfying the distance criterion only in the scan cells of a selected group, among the grouped scan cells, as the first weighting scan cell.
The method may include: analyzing a correlation between input signals of an element receiving a second output signal of the first control point circuit and a first output signal of a first load scan cell providing an output signal to the first weighting scan cell; determining a second weighting scan cell satisfying the distance criterion with respect to the control point node, among the at least one weighting scan cell, based on the correlation; removing the first control point circuit from the logically synthesized circuit; and inserting a second control point circuit, sharing one or more elements with the weight applying circuit connected to the second weighting scan cell, into the logically synthesized circuit.
The inserting of the first control point circuit into the logically synthesized circuit may include: inserting the first control point circuit, sharing a NAND gate or a first AND gate of the weight applying circuit, into the logically synthesized circuit.
The method may include: inserting the first control point circuit into the logically synthesized circuit to cause a second AND gate or an OR gate of the first control point circuit to be configured to receive an output signal of the NAND gate or the first AND gate of the weight applying circuit.

While some example embodiments have been shown and described above, it will be apparent to those skilled in the art that modifications and variations could be made without departing from the scope of the present inventive concepts as defined by the appended claims.

What is claimed is:

1. A processor, comprising:
a pattern generating circuit configured to transmit a test pattern of pseudo-random numbers;
a scan chain, the scan chain including a plurality of scan cells connected in a chain, the scan chain configured to scan-in the test pattern to the plurality of scan cells and scan-out a test response of a circuit-under-test based on the test pattern, the plurality of scan cells coupled to at least one logic circuit of the circuit-under-test;
a weight applying circuit and a control point circuit, the weight applying circuit and the control point circuit configured to share at least one shared element, the weight applying circuit configured to transmit a weighted output signal to the circuit-under-test by applying a weight to an output signal of at least one scan cell among the plurality of scan cells based on an operation performed by the at least one shared element, the control point circuit configured to selectively control blocking of an internal signal of the circuit-under-test and transmitting a pre-configured logic value to the circuit-under-test or transmitting the internal signal to the circuit-under-test without blocking, such that one of the pre-configured logic value or the internal signal is transmitted to the circuit-under-test based on the operation performed by the at least one shared element; and
a compacting circuit configured to transmit a signature obtained based on compacting the test response of the circuit-under-test.

2. The processor of claim 1, wherein:
the weight applying circuit is configured to receive the output signal of the at least one scan cell, apply the weight to the output signal to generate the weighted output signal, and transmit the weighted output signal to the circuit-under-test, the weight applying circuit configured to perform the applying and the transmitting based on the operation performed by the at least one shared element.

3. The processor of claim 1, wherein:
the control point circuit is configured to block the internal signal of the circuit-under-test and transmit the pre-configured logic value to the circuit-under-test, based on the control point circuit operating in a test mode.

4. The processor of claim 3, wherein:
the control point circuit is configured to transfer the internal signal of the circuit-under-test to the circuit-under-test without blocking the internal signal, based on the control point circuit operating in a normal mode.

5. The processor of claim 1, wherein:
the weight applying circuit is configured to receive, as input signals, a first output signal of the at least one scan cell and a second output signal of at least one separate scan cell among the plurality of scan cells of the scan chain.

6. The processor of claim 5, wherein:
the weight applying circuit is configured to receive, as part of the input signals, second output signals of at least two scan cells among the plurality of scan cells of the scan chain, the second output signals including the second output signal of the at least one separate scan cell.

7. The processor of claim 5, wherein:
the weight applying circuit is configured to:
receive the first output signal of a first scan cell among the plurality of scan cells and the second output signal of a second scan cell among the plurality of scan cells, and
apply the weight to the first output signal of the first scan cell to generate the weighted output signal;
the control point circuit is configured to:
receive the second output signal of the second scan cell,
receive a test enable signal,
receive the internal signal from the circuit-under-test, and
selectively block the internal signal and apply the pre-configured logic value to the circuit-under-test, based on both the second output signal and the control point circuit operating in a test mode; and
the first scan cell is configured to receive the second output signal of the second scan cell.

8. The processor of claim 1, wherein:
the at least one shared element includes a NAND gate or an AND gate.

9. The processor of claim 1, wherein:
the processor is configured to shift-in the test pattern to the scan chain, apply the test pattern to the circuit-under-test, capture the test response of the circuit-under-test, and shift-out the test response to the scan chain.

10. The processor of claim 1, wherein:
the at least one shared element comprises a first element configured to receive a test enable signal; and
the weight applying circuit and the control point circuit are configured to operate in a test mode based on the test enable signal.

11. The processor of claim 10, wherein:
the plurality of scan cells comprise a first scan cell configured to transmit a first output signal and a second scan cell configured to transmit a second output signal;
the weight applying circuit is configured to apply the weight to the first output signal of the first scan cell to generate the weighted output signal; and
the first scan cell and the first element are configured to receive the second output signal.

12. A method of operating a processor, the method comprising:
shifting-in a test pattern of pseudo-random numbers to a scan chain, the scan chain including a plurality of scan cells connected in a chain, the test pattern of the pseudo-random numbers being generated by a pattern generating circuit;
transmitting a weighted test pattern to a circuit-under-test based on applying, by a weight applying circuit, a weight to an output signal of at least one scan cell among the plurality of scan cells, the applying based on an operation performed by at least one shared element;
blocking, by a control point circuit sharing the at least one shared element with the weight applying circuit, an internal signal of the circuit-under-test and applying a pre-configured logic value to the circuit-under-test, the blocking and the applying based on the operation of the at least one shared element; and
scanning-out a response of the circuit-under-test based on the weighted test pattern and the pre-configured logic value.

13. The method of claim 12, further comprising:
receiving, by the at least one shared element, a test enable signal;
applying, by the weight applying circuit, the weight to the output signal of the at least one scan cell based on the test enable signal; and
blocking, by the control point circuit, the internal signal and applying the pre-configured logic value to the circuit-under-test based on the test enable signal.

14. A method of designing a processor, the method comprising:
logically synthesizing a circuit to generate a logically synthesized circuit;
analyzing deterministic patterns generated by an automatic test pattern generator based on the logically synthesized circuit to determine at least one weighting scan cell, into which a weight applying circuit is to be inserted, in the logically synthesized circuit;
inserting the weight applying circuit into the logically synthesized circuit based on the at least one weighting scan cell;
determining a control point node into which a first control point circuit is to be inserted, based on the logically synthesized circuit;
determining a first weighting scan cell, from among the at least one weighting scan cell, that satisfies a distance criterion with respect to the control point node; and
inserting the first control point circuit, sharing one or more elements with the weight applying circuit connected to the first weighting scan cell, into the logically synthesized circuit.

15. The method of claim 14, wherein:
the determining of the control point node into which the first control point circuit is to be inserted comprises:
selecting at least one scan cell in a deterministic pattern of the deterministic patterns in which a ratio of care bits is greater than or equal to a pre-configured criterion.

16. The method of claim 14, comprising:
grouping scan cells based on a ratio of bits having a pre-configured logic value, among care bits of the deterministic patterns.

17. The method of claim 16, wherein:
the determining of the first weighting scan cell comprises:
selecting a particular scan cell satisfying the distance criterion only in the scan cells of a selected group, among the grouped scan cells, as the first weighting scan cell.

18. The method of claim 14, comprising:
analyzing a correlation between input signals of an element receiving a second output signal of the first control point circuit and a first output signal of a first load scan cell providing an output signal to the first weighting scan cell;
determining a second weighting scan cell satisfying the distance criterion with respect to the control point node, among the at least one weighting scan cell, based on the correlation;
removing the first control point circuit from the logically synthesized circuit; and
inserting a second control point circuit, sharing one or more elements with the weight applying circuit connected to the second weighting scan cell, into the logically synthesized circuit.

19. The method of claim 14, wherein:
the inserting of the first control point circuit into the logically synthesized circuit comprises:
inserting the first control point circuit, sharing a NAND gate or a first AND gate of the weight applying circuit, into the logically synthesized circuit.

20. The method of claim 19, comprising:
inserting the first control point circuit into the logically synthesized circuit to cause a second AND gate or an OR gate of the first control point circuit to be configured to receive an output signal of the NAND gate or the first AND gate of the weight applying circuit.
